(19) United States
(12) Patent Application Publication
(10) Pub. No.: US 2023/0203682 A1
(43) Pub. Date: Jun. 29, 2023

(54) AN ANION EXCHANGE ELECTROLYZER HAVING A PLATINUM-GROUP-METAL FREE SELF-SUPPORTED OXYGEN EVOLUTION ELECTRODE

(71) Applicant: University of Delaware, Newark, DE (US)

(72) Inventors: Yushan Yan, Hockessin, DE (US); Junwu Xiao, Newark, DE (US); Alexandra Oliveria, Elkton, MD (US); Lan Wang, Newark, DE (US); Yun Zhao, Newark, DE (US); Teng Wang, Newark, DE (US); Junhua Wang, Newark, DE (US); Brian Setzler, Newark, DE (US)

(21) Appl. No.: 17/923,355

(22) PCT Filed: May 4, 2021
(86) PCT No.: PCT/US2021/030696

§ 371 Date: Nov. 4, 2022

Related U.S. Application Data
(60) Provisional application No. 63/019,968, filed on May 4, 2020.

(51) Int. Cl. C25B 11/091; C25B 1/04; C25B 9/19; C25B 11/032; C25B 13/08; C25B 11/065; C25B 11/081

(52) U.S. Cl. CPC C25B 11/091; C25B 1/04; C25B 9/19; C25B 11/032; C25B 13/08; C25B 11/065; C25B 11/081

(57) ABSTRACT

Fluoride-containing nickel iron oxyhydroxide electrocatalysts for use as anodes in anion exchange membrane electrolyzers for generating hydrogen gas.

### CROSS REFERENCE TO RELATED APPLICATIONS

This application claims benefit of U.S. Provisional Application No. 63/019,968 filed May 4, 2020, the entire disclosure of which is herein incorporated by reference.

### STATEMENT REGARDING FEDERALLY SPONSORED RESEARCH OR DEVELOPMENT

This invention was made with Government support under grants DE-AR0000771 and DE-AR0001149 awarded by Advanced Research Projects Agency—Energy (ARPA-E) U.S. Department of Energy. The Government has certain rights in the invention.

### FIELD OF THE INVENTION

Fluoride-containing nickel iron oxyhydroxide electrocatalysts are disclosed. These electrocatalysts can be used in electrochemical devices such as anion exchange membrane electrolyzers (AEMELs) and in methods for generating hydrogen gas (H₂).

### BACKGROUND OF THE INVENTION

Green hydrogen generation by low-temperature water electrolysis is considered a promising large-scale and long duration technology for storage and movement of intermittent renewable wind and solar energy across continents and between industrial sectors^{[1]}. In particular, green hydrogen has a unique capability to eliminate the carbon emissions of industries that are otherwise difficult to decarbonize, such as ammonia synthesis, steel refining, and transportation, notably with heavy duty vehicles.

Traditional alkaline electrolyzers (AELs) operated with 25-40 wt. % potassium hydroxide (KOH) or sodium hydroxide (NaOH) electrolytes have served as the commercial technology since 1927^{[2,3]}, AELs exhibit a long lifetime of 30-40 years, and their inexpensive platinum group metal (PGM) free catalysts and stack components give rise to a low capital cost^{[3]}. However, they suffer from low voltage efficiency due to high internal resistance caused by gas bubbles that form within the liquid electrolyte and adsorb onto the electrode surface, as well as thick diaphragms, especially at high current densities^{[4]}. The concentrated liquid electrolyte also results in shunt currents which cause efficiency losses, as well as hardware corrosion issues Because of slow ion transport through liquid electrolytes, AELs also experience slow transient response, making it difficult to utilize intermittent renewable energy^{[4]}.

Hydroxide exchange membrane electrolyzers (HEMELs) provide an alternative solution that preserves the low-cost benefits of AELs while using the improved design of proton exchange membrane electrolyzers (PEMELs), which benefits from a solid electrolyte membrane and zero-gap configuration to reduce internal resistance. By using this configuration with a hydroxide-conducting polymer membrane instead of the harsh acidic proton-conducting membrane of PEMELs, HEMELs could remove the need for expensive PGM electrocatalysts and precious metal-coated titanium-based stack materials. The zero-gap solid electrolyte assembly also allows for high voltage efficiency, large current density, fast dynamic response and the ability to operate at differential pressures^{[5]}.

One of the greatest improvements of HEMELs over AELs is the potential to operate with a water feed instead of corrosive alkaline electrolyte. However, for water-fed HEMELs to achieve high performance, an advanced hydroxide exchange membrane (HEM) and hydroxide exchange ionomer (HEI) are used. These two components are responsible for the hydroxide ion transport pathways through the electrolyzer. Thus, the HEM and HEI exhibit high hydroxide conductivity and excellent chemical and mechanical stability to avoid a reduction in electrolyzer performance and durability.

Wang et al.^{[6]} reported the performance of water-fed HEMEL single cell using PGM catalysts (Pt black in the cathode and IrO₂ in the anode) and an unstable commercial HEM and HEI. They achieved a current density of 399 mA cm⁻² at 1.8 V with poor durability in pure water. Another HEMEL study with PGM-free catalysts (Ni—Mo in the cathode and Ni—Fe in the anode) and a self-made HEM and HEI demonstrated a current density close to 300 mA cm⁻² at 1.8 V with a short-term durability of 8 hours^{[7]}. In a more recent study, Kim et al.^{[8]} reported a high performance PGM-free HEMEL with a model quaternized polyphenylene HEM and quaternary ammonium polystyrene HEI with high ion exchange capacity (IEC) (3.3 mequiv, g⁻¹). Single cell tests yielded a current density of 906 mA cm² at 1.8 V but even this showed short-term performance drops (<10 h) and instability in the long term. One of the main reasons for reduced performance is that catalysts are easily washed out during operation, since use of a high IEC HEI weakens the binding strength with the catalyst such that it is difficult to hold the catalyst while withstanding the scour of water flow and gas evolution.

Several commercial HEMS and HEIs have been developed recently, including Orion TMI™, a quaternary ammonium-functionalized aromatic polymer produced by Orion Polymer^{[9]}), Ecolectro developed Aemion, a phosphonium-functionalized polyethylene conducting polymer^{[10]}, and Ionomr Innovations Inc. synthesized polybenzimidazolium HEIs and HEMs^{[11]}. All experienced a point at which further increase in conductivity and IEC was impeded by dissolution in water.

Another critical limiting factor to HEMEL performance is electrochemical reaction resistance, which is dependent on the catalytic activities of the electrodes employed, especially for the sluggish oxygen evolution kinetics in the anode^{[12]}. Transition metal oxyhydroxides (MOOH, where M=Fe, Co, and Ni) are regarded as one of the most promising OER candidates among PGM-free catalysts in an alkaline environment^{[13-15]}. They are also proposed to be the realistic active species of the oxides, dichalcogenides, nitrides, and phosphides that are generated from irreversible surface reconstruction during the catalytic processes^{[16-22]}. However, a large overpotential (>400 mV) is still required to meet the level of industrial applications (>500 mA cm⁻²).

Therefore, a need exists for oxygen evolution electrocatalysts for use as an anode in AEMELs and HEMELs that are resistant to being washed out during operation of the electrcilyzer to improve performance and long term stability.

### BRIEF SUMMARY OF THE INVENTION

The present disclosure is directed to fuel cell systems, electrochemical pumps, and methods of using these to reduce the carbon dioxide concentration in air and to generate electricity.

For example, the disclosure is directed to a fluoride-containing nickel iron oxyhydroxide electrocatalyst.

Additionally, the disclosure is directed to platinum-group-metal (PGM)-free self-supported oxygen evolution electrode comprising the electrocatalyst within pores of a gas diffusion layer comprising a nickel foam.

Further, the disclosure is directed to an anion exchange membrane electrolyzer for generating hydrogen from water. The AEMEL comprises an anode comprising an anode electrocatalyst comprised of the fluoride-containing nickel iron oxyhydroxide eiectrocatalyst for forming oxygen gas and water from hydroxide ions; a cathode comprising a cathode electrocatalyst for forming hydrogen gas and hydroxide ions from water; and an anion exchange membrane being adjacent to and separating the anode and the cathode, and for transporting hydroxide ions from the cathode to the anode.

The disclosure is also directed to a method of preparing the fluoride-containing nickel iron oxyhydroxide electrocatalyst. The method comprises

immersing a compressed nickel foam in an O₂-rich aqueous solution comprising iron nitrate hexahydrate and sodium fluoride for at least 8 hours under flow of oxygen above the surface of the solution to form the fluoride-containing nickel iron oxyhydroxide electrocatalyst; and washing the fluoride-containing nickel iron oxyhydroxide electrocatalyst with water.

Other objects and features will be in part apparent and in part pointed out hereinafter.

### BRIEF DESCRIPTION OF THE SEVERAL VIEWS OF THE DRAWING

FIG. 1, panel (a) is a schematic illustration of the formation mechanism of fluoride-incorporated nickel iron oxyhydroxides via the spontaneous dissolved oxygen and galvanic corrosion processes. FIG. 1, panels (b) and (c) are plots of (b) XRD patterns and (c) high-resolution F is XPS spectra of FeₓNi_{y}OOH and FeₓNi_{y}OOH-20F. FIG. 1, panels (d)-(f) are (d) SEM, (e) TEM, and (f) HRTEM images of FeₓNi_{y}OOH-20F.

FIG. 2 is a schematic of a single cell AEMEL.

FIG. 3, panels (a)-(d) are low- and high-magnification SEM images of (a and b) the surface and (c and d) the cross-section of the Pt/C/HEI cathode.

FIG. 4 is a graph of the polarization curves of HEMELs working with KOH aqueous solutions at 80° C.

FIG. 5 is a graph of the polarization curve of an AEL using a Pt/C/HEI cathode, FeₓNi_{y}OOH-20F anode, Zirfon membrane (500 μm) and 1.0 M KOH aqueous electrolyte at 80° C.

FIG. 6, panel (a) is a schematic illustration of the configuration of water-fed HEMELs using a PVC cathode and self-supported FeₓNi_{y}OOH-20F anode. FIG. 6, panel (b) is a graph of the polarization curves of water-fed HEMELs using FeₓNi_{y}OOH-20F and VIC anode catalysts at cell temperatures of 80° C. and 90° C. FIG. 6, panel (c) is a plot of a comparison of the cell performances (j_{1.8}) of water-fed HEMELs of the invention and of the literature (“this work”).

FIG. 7, panels (a) and (b) are (a) the polarization and (b) EIS curves of water-fed HEMELs as a function of HEI loadings at 80° C. The EIS data was measured at a current density of 100 mA cm⁻², FIG. 7, panel (c) illustrates the equivalent circuits for simulating the EIS data. The Nyquist plots were fitted into the equivalent circuits composed of a resistor in series with three other resistors, each in parallel with a constant phase element (CPE).^{[58]} R₁ represents the ohmic resistance of the current collector, catalyst layer, membrane and all contact resistances. R₂ corresponds to the charge transfer resistance of the electronic/ionic conductive elements.^{[58]} R₃ is related to the kinetic resistance of the oxygen and hydrogen evolution reactions. The oxygen evolution reaction under the catalysis of PGM free FeₓNi_{y}OOH-20F is much slower than the hydrogen evolution reaction under the catalysis of PGM Pt/C catalyst. Therefore, compared with that at the anode, the kinetic resistance at the cathode is considered to be negligible. R₄ is associated with the mass transport effects. FIG. 7, panel (d) is a graph of the simulated R₁, R₂, R₃, and R₄ values at different HEI loadings.

FIG. 8 is a graph of short-term durability performance of the water-fed HEMEL at current densities of 100 to 500 mA cm⁻² and 80° C.,

FIG. 9, panels (a), (c) and (d) are graphs of (a) long-term stability performance of water-fed HEMELs at 200 mA cm⁻² and 80° C., (c) XRD pattern, and (d) high-resolution F 1s XPS spectra of FeₓNi_{y}OOH-20F/HEI anode obtained after a continuous 160 h of operation at 200 mA cm⁻² and 80° C. FIG. 9, panel (b) is an SEM image of the FeₓNi_{y}OOH-20F/HEI anode obtained after a continuous 160 h of operation at 200 mA cm⁻² and 80° C.

FIG. 10 is a graph of long-term stability performance of the water-fed HEMEL at 500 mA cm² and 80° C.

FIG. 11 is a bar graph of the Fe/Ni molar ratios in FeₓNi_{y}OOH and FeₓNi_{y}OOH-nF (n=10, 20, and 30) determined using a microwave plasma-atomic emission spectrometer (MP-AES).

FIG. 12, panels (a)-(d) are SEM images of (a) FeₓNi_{y}OOH, (b) FeₓNi_{y}OOH-10F, (c) FeₓNi_{y}OOH-20F, and (d) FeₓNi_{y}OOH-30F,

FIG. 13, panels (a)-(d) are graphs of (a) CV curves, (b) polarization curves, (C) Tafel slopes, and (d) η₁₀₀ versus j_{ECSA}©1.55 V of nickel iron oxyhydroxide (FeₓNi_{y}OOH), fluoride-incorporated nickel iron oxyhydroxide (FeₓNi_{y}OOH-nF, where n is the F⁻ concentration of 10, 20 or 30 mall in the reactants), and PGM Ir/C (20 wt. %) catalysts, which are measured in an O₂-saturated 1.0 M KOH solution.

FIG. 14, panels (a) and (b) are (a) an SEM image and (b) corresponding EDX analysis of a (Fe, Co, Ni)OOH layer prepared by immersing Ni foam into an O₂-saturated Fe(NO₃)₃ and Co(NO₃)₂ solution.

FIG. 15 is a graph of the electrochemical impedance spectroscopy (EIS) of FeₓNi_{y}OOH and FeₓNi_{y}OOH-20F electrodes measured at 1.60 V vs. RHE with an AC oscillation of 10 mV amplitude over frequencies from 100 kHz to 100 mHz. EIS spectra are fitted using an equivalent circuit composed of the ohmic resistance (Rₛ) in series with two parallel units of the charge transfer resistance at the interfaces of the catalysts and the electrolyte (R_{ct}), mass transport resistance (Rₘₐₛₛ), and constant phase elements (CPE_{ct} and CPEₘₐₛₛ)(Inset).^{[10,11]}

FIG. 16, panels (a) and (b) are CV curves of (a) FeₓNi_{y}OOH and (b) FeₓNi_{y}OOH-20F measured in the non-faradic potential region, and FIG. 16, panel (c) is a graph of the corresponding electric double layer capacitance (C_{dl}).

FIG. 17, panels (a) and (b) are graphs of the 1st˜20th CV cycles of (a) FeₓNi_{y}OOH and (b) FeₓNi_{y}OOH-20F catalysts measured in O₂-saturated 1.0 M KOH solution. In comparison with FeₓNi_{y}OOH, the OER current has increased for FeₓNi_{y}OOH—F-2 from the 1st to 20th CV cycles.

FIG. 18, panels (a)-(c) are high-resolution (a) Ni 2p, (b) Fe 2p, and (c) O 1s XPS spectra of FeₓNi_{y}OOH and FeₓNi_{y}OOH-20F. The peaks at 856.1 eV and 873.8 eV in the high-resolution Ni 2p XPS spectra are ascribed to the 2p/3/2 and 2p1/2 peaks of Ni (II)-OH, respectively,^{[50]} and the peaks at the binding energies of 861.7 eV and 879.8 eV belong to the satellite peaks. In the high-resolution Fe 2p XPS spectra, the peaks at 711.2 eV and 724.4 eV are ascribed to the 2p3/2 and 2p1/2 peaks of FeO(OH), respectively,^{[5,6]} and the peaks at 714.2 eV and 727.4 eV are characteristic of Fe³⁺.^{[53]} The corresponding shake-up satellite peaks are located at 719.0 eV and 732.6 eV. The peaks at the binding energies of 530.0 eV, 531.5 eV, and 533.0 eV in the high-resolution O 1s XPS correspond to the Fe/Ni—O, O—H, and adsorbed H₂O, respectively.^{[8,9]}

FIG. 19, panels (a)-(d) are high-resolution (a) F is, (b) Ni 2p, (c) Fe, 2p, and (d) O 1s XPS spectra of FeₓNi_{y}OOH-20F recorded after continuous 20 CV cycles in O₂-saturated 1.0 M KOH solution. High resolution Ni 2p, Fe 2p, and O 1s spectra of FeₓNi_{y}OOH-20F after 20 repetitive CV cycles are similar to the original FeₓNi_{y}OOH-20F, while the F 1s peak corresponding to the (Fe, Ni)—F bond has disappeared, suggesting F ions are leached during the CV cycling.

FIG. 20 shows a comparison of the cell performance of HEMELs working with 1.0 M KOH solution of the inventive HEMEL and the literature.

FIG. 21, panels (a)-(c) are high-resolution (a) Ni 2p, (b) Fe 2p, and (c) O 1s XPS spectra of a FeₓNi_{y}OOH-20F/HEI anode obtained after the stability test for 160 h at 200 mA cm⁻².

FIG. 22 is an SEM image of a FeₓNi_{y}OOH-20F/HEI anode obtained before the stability test.

Corresponding reference characters indicate corresponding parts throughout the drawings.

### DETAILED DESCRIPTION OF THE INVENTION

An in-situ dissolved oxygen and galvanic corrosion method has been developed to synthesize fluoride-containing nickel iron oxyhydroxide electrocatalysts. Preferably, vertically aligned fluoride-incorporated nickel iron oxyhydroxide nanosheet arrays are formed on nickel foam for use as a highly active platinum-group-metal (PGM)-free self-supported oxygen evolution electrode. This electrode can be integrated with a highly conductive anion exchange membrane and ionomers into an anion exchange membrane electrolyzer (AEMEL). For example, the vertically aligned fluoride-incorporated nickel iron oxyhydroxide nanosheet arrays formed on nickel foam can serve as an anode when integrated with a highly conductive poly(aryl piperidinium) (PAP) hydroxide exchange membrane and ionomers into a pure water-fed hydroxide exchange membrane electrolyzer (HEMEL). Such an HEMEL has achieved performance of 1020 mA cm⁻² at 1.8 V and 90° C. and can be stably operated continuously at 200 mA cm⁻² for 160 hours without the electrocatalyst washing out. Such AEMELs and HEMELs can be used for massively producing low-cost hydrogen using intermittent renewable energy sources.

The present disclosure is directed to a fluoride-containing nickel iron oxyhydroxide electrocatalyst. The electrocatalyst is designated as FeₓNi_{y}OOH-nF wherein n is the F⁻ molar concentration in the reactants used in the electrocatalyst synthesis reaction, x and y are the molar ratios of Fe and Ni in the FexNiyOOH-nF catalyst, respectively, which are measured via microwave plasma-atomic emission spectrometry (MP-AES). The electrocatalyst can be used as an anode in an AEMEL such as an HEMEL.

The electrocatalyst can have a single F 1s peak as exhibited by high-resolution fluoride (F) 1s X-ray photoelectron spectroscopy spectra. Preferably, the single F 1s peak is at a binding energy of 684.0 eV.

The electrocatalyst can comprise a three-dimensional sponge-like network structure as determined by scanning electron microscopy (SEM) imaging.

The Fe/Ni molar ratio of the electrocatalyst as determined by microwave plasma-atom emission spectrometry (MP-AES) is less than 4.0, and preferably, from about 2.0 to about 3.2.

The electrocatalyst can have the formula FeₓNi_{y}OOH wherein x ranges from about 0.75 to about 0.83, and y ranges from about 0.26 to about 0,38.

The electrocatalyst can further comprise at least one metal in addition to Fe and Ni, the at least one metal comprising Ce, Cr, Cu, Co, Mo, Ru, Pd, Pt, Ir, Rh, Os, Ag, Au, Re, Ta, Ti, V, W, Mn, Zn, Sn, Sb, In, Ga, iii, Pb, or Zr, For example. Co is present in the electrocatalyst of Example 4.

The electrocatalyst can be in the form of vertically oriented and interpenetrating nanosheet arrays as determined by high-angle annular dark-field scanning transmission electron microscopy (HAADF-STEM). Each nanosheet can have a thickness of about 2 to 3 nm as determined by high magnification transmission electron microscopy (TEM) imaging.

The fluoride-containing nickel iron oxyhydroxide electrocatalyst can be in the form of nanosheet arrays on compressed nickel foam. Such nanosheet arrays can be in-situ grown on the nickel foam to form a catalyst coated substrate.

The fluoride-containing nickel iron oxyhydroxide electrocatalysts exhibit significantly greater catalytic activity than other Ni—Fe catalysts in alkaline electrolyte such as KOH due to fluorine leaching-induced surface reconstruction as shown in Table 1. More specifically, as fluorine ion leaches from the electrocatalysts, it induces surface reconstruction to expose more NiOOH active sites to increase catalytic activity.

TABLE 1
Comparison of the oxygen evolution reaction (OER) performance
of fluorine-incorporated iron nickel oxyhydroxide catalysts
with previously reported Ni—Fe catalysts.

| Catalysts | Substrates | j/mA cm−2 | η/mV | References |
|---|---|---|---|---|
| FeₓNi_{y}OOH—20F | Compressed | 100 | 280 | Inventive |
| | Ni foam | 500 | 348 | catalyst |
| Ir/C | Compressed | 100 | 370 | Comparative |
| | Ni foam | | | |
| NiFe—F—OH-SR | Ni foam | 100 | 228 | [23] |
| NiFe-LDH | Fe foam | 100 | 280 | [15] |
| Cu@NiFe-LDH | Cu foam | 100 | 281 | [29] |
| NiFe hydroxides | Ni foam | 100 | 370 | [14] |
| NiFe LDH | Ni foam | 30 | 300 | [30] |
| Ni₆₀Fe₃₀Mn₁₀ | Ni foam | 500 | 360 | [31] |

Another aspect of the disclosure is directed to a method of preparing a fluoride-containing nickel iron oxyhydroxide electrocatalyst. The method comprises immersing a compressed nickel foam in an O₂-rich aqueous solution comprising iron nitrate hexahydrate and sodium fluoride for at least 8 hours under flow of oxygen above the surface of the solution to form the fluoride-containing nickel iron oxyhydroxide electrocatalyst; and washing the fluoride-containing nickel iron oxyhydroxide electrocatalyst with water.

The method can further comprise compressing the nickel foam at a force of at least 4448 N to form the compressed nickel foam. For example, the nickel foam can be compressed with a force of about 4448 N to about 13344 N, or about 4448 N (1000 pounds-force).

The method can further include immersing the compressed nickel foam in an aqueous acidic solution to remove residual oxides from the compressed nickel foam and then washing the compressed nickel foam with water to remove the acidic solution.

The iron nitrate hexahydrate and the sodium fluoride can be present in the O₂-rich aqueous solution in a molar ratio ranging from about 2:1 to about 1:1.5.

The O₂-rich aqueous solution can be formed by bubbling oxygen gas through an aqueous solution comprised of iron nitrate hexahydrate and sodium fluoride.

The flow of oxygen above the surface can be at a flow rate of from about 40 to about 100 scorn.

The method can further comprise removing the fluoride-containing nickel iron oxyhydroxide electrocatalyst from the compressed nickel foam. For example, the eiectrocatalyst can be removed from the nickel foam by ultra-sonication.

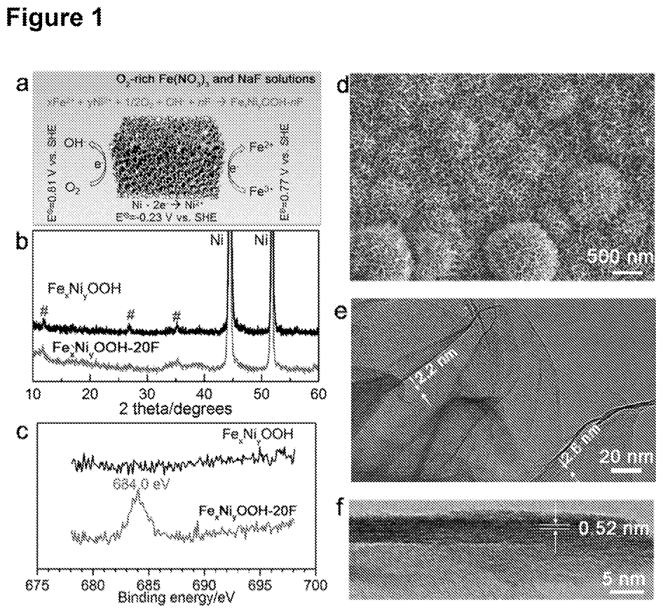

The fluoride-containing nickel iron oxyhydroxide catalyst can b situ grown on compressed nickel foam using a galvanic corrosion process. When compressed nickel foams are immersed into an O₂-rich Fe(NO₃)₃ and NaF solution, the oxidizing agents (Fe³⁺ and O₂) drive the oxidation of the surface Ni species into Ni²⁺ (FIG. 1a), The foams are then coordinated with OH⁻ and F⁻ anions, where the F concentration is varied. Full characterization data of the FeₓNi_{y}OOH-nF is included in Example 2.

The in-situ growth mechanism for forming the FeₓNi_{y}OOH-nF anode provides several benefits over other electrodes fabricated using a catalyst coated substrate (CCS) configuration, The electrocatalyst is directly grown on a compressed nickel foam substrate via a facile galvanic\dissolved oxygen corrosion mechanism, in which the nickel foam substrate serves as both a catalyst support and a gas diffusion layer (GDL) to replace the expensive titanium micro-porous layer (MPL) found in PEMELs.

The conductive nickel foam provides an electronic channel for catalytic active sites. These active sites are present throughout the pores of the GDL instead of being sprayed on the GDL's surface alone, which increases the electrocatalyst utilization.

The growth mechanism promotes stable contact between the electrocatalyst and GDL because the electrocatalyst is directly grown on the GDL and the GDL is one of the reactants during the synthesis process, Such stable contact eliminates issues with catalyst loss at high current density and for long-term operation, such that 160 h of stability using a high IEC HEI was demonstrated for the first time.

The easy one-step immersion process used to make the electrocatalysts also eliminates the need for tedious hand-spraying fabrication methods.

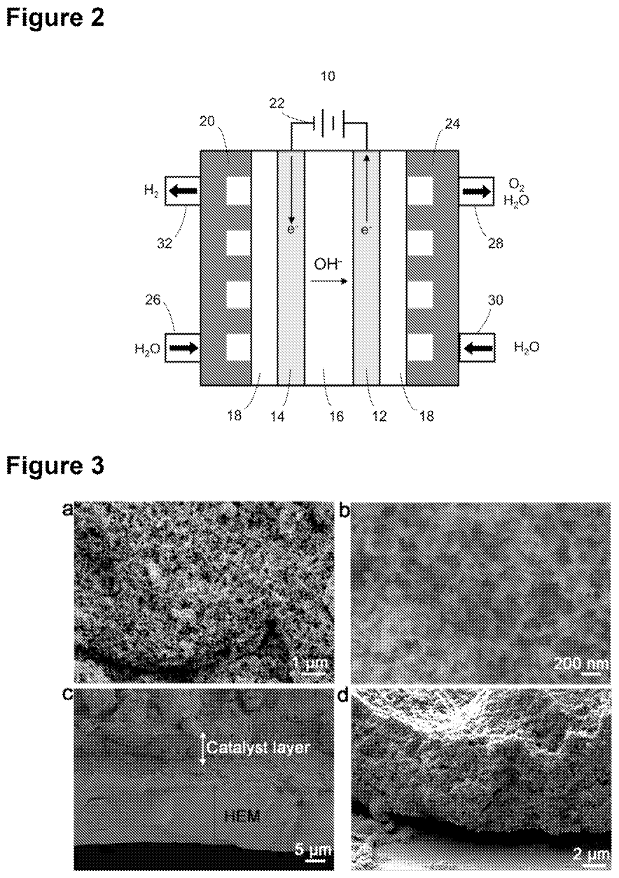

Another aspect of the disclosure is directed to an AEMEL used to generate hydrogen gas. A schematic of one example of the AEMEL is shown in FIG. 2. FIG. 2 shows a single cell AEMEL configuration 10 having an anode 12 comprising an anode electrocatalyst comprised of the fluoride-containing nickel iron oxyhydroxide electrocatalyst for forming oxygen gas and water from hydroxide ions. The anode 12 can further comprise a substrate such as a nickel foam such that the anode is in the form of a cathode coated substrate. The substrate also serves as a gas diffusion layer on the anode side of the AEMEL. A cathode 14 comprises a cathode electrocatalyst for forming hydrogen gas and hydroxide ions from water. An anion exchange membrane 16 is adjacent to and separates the anode 12 and the cathode 14, and transports hydroxide ions from the cathode 14 to the anode 12. A gas diffusion layer 18 can be present between the cathode 14 and a cathode end plate 20. A DC power supply 22 conducts electrons from anode to cathode. An anode end plate 24 is adjacent the anode. A feed inlets 26 and 30 supply water or an aqueous alkaline electrolyte such as KOH or NaOH to the AEMEL. Water and oxygen are removed from outlet 28 and 30 on the anode side. Hydrogen gas is removed from outlet 32 on the cathode side. The anode reaction is the oxygen evolution reaction (OER):

4OH− [symbol] O₂+2H₂O+4e⁻

and the cathode reaction is the hydrogen evolution reaction (HER):

2H₂O+e⁻ [symbol] H₂+2OH⁻

The water feed to the cathode 14 can contain a hydroxide-conducting electrolyte for forming oxygen gas and water from hydroxide ions. The hydroxide-conducting electrolyte can comprise KOH or NaOH, with KOH being preferred.

It is preferred that the feed stream into the feed inlet 26 is pure water that does not include any alkaline electrolyte to minimize corrosion.

The fluoride-containing nickel iron oxyhydroxide electrocatalyst can be within pores of a gas diffusion layer comprising a nickel foam.

The anion exchange membrane 16 can comprise an anion exchange polymer and an electronically-conductive material or an electronically-conductive anion exchange polymer. For example, the anion exchange polymer can comprise quaternary ammonium or imidazolium groups and a polymer backbone not having ether groups.

The anion exchange polymer can comprise poly(aryl piperidinium), alkylammonium-functionalized poly(aryl alkylene), substituted-imidazolium-functionalized poly(aryl alkylene), alkylammonium-functionalized poly(styrene), substituted-imidazolium-functionalized poly(styrene), alkylammonium-functionalized poly(styrene-co-divinylbenzene), substituted-imidazolium-functionalized poly(styrene-co-divinylbenzene), alkylammonium-functionalized poly(styrene-block-ethylene-co-butadiene-block-styrene), substituted-imidazolium-functionalized, poly(styrene-block-ethylene-co-butadiene-block-styrene), alkylammonium-functionalized poly(ethylene), substituted-imidazolium-functionalized poly(ethylene), alkylammonium-functionalized poly(tetrafluoroethylene), substituted-imidazolium-functionalized poly(tetrafluoroethylene), alkylammonium-functionalized poly(ethylene-co-tetrafluoroethylene), substituted-imidazolium-functionalized poly(ethylene-co-tetrafluoroethylene), polyethyleneimine, poly(diallyl ammonium), or a combination thereof. Poly(arylpiperidinium) is preferred.

The electronically-conductive material can comprise carbon, nickel, stainless steel, silver, an electronically conductive polymer, or a combination thereof. For example, the electronically conductive material can comprise nanowires or nanotubes.

The cathode electrocatalyst can comprise silver, a silver alloy, carbon-supported silver, a carbon-supported silver alloy, platinum, a platinum alloy, carbon-supported platinum, a carbon-supported platinum alloy, palladium, a palladium alloy, carbon-supported palladium, a carbon-supported palladium alloy, manganese oxide, a carbon-supported manganese oxide, cobalt oxide, a carbon-supported cobalt oxide, heteroatom-doped carbon (X—C, where X comprises one or more of N, C, B, P, S, Se, or O), metal-heteroatom-carbon (M-X—C, where X comprises one or more of N, C, B, P, S, Se, or O, and M comprises one or more of Fe, Ce, Cr, Cu, Co, Mo, Ni, Ru, Pd, Pt, Ir, Rh, Os, Ag, Au, Re, Ta, Ti, V, W, Mn, Zn, Sn, Sb, In, Ga, Si, Pb, or Zr), a perovskite (ABX₂, where A comprises one or more of Ca, Sr, Ba, Sc, La, Ce, Zr, Cu, Zn, Sb, Bi, B comprises one or more of Al, Ti, Mn, Fe, Co Ni, W, Pd, and X comprises one or more of O, Se, S), a carbon-supported perovskite (ABX₃ where A comprises one or more of Ca, Sr, Ba, Sc, V, La, Ce, Zr, Cu, Zn, Sb. Bi, B comprises one or more of Al, Ti, Mn, Fe, Co Ni, W, Pd, and X comprises one or more of O, Se, S), or a combination thereof. Carbon-supported platinum is preferred.

An ionomer interlayer can be applied directly to the cathode side of the anion exchange membrane before application of the cathode catalyst. Such interlayer provides a hydroxide-conducting network. All experiments used PAP membranes and ionomers. The PAP membranes and ionomers are described in U.S. Pat. No. 10,290,890, U.S. application Ser. No. 16/651,622, and PCT Publication No. WO 2019/068051, herein incorporated by reference in their entirety. A preferred cathode ionomer is PAP-TP-85.

The gas diffusion layer 18 on the cathode side of the AEMEL can comprise any suitable material known in the art such as carbon paper. For example, the GDL can comprise Toray Paper 060 with 5% and 10% wet proofing, and/or Sigracet 29BC.

An ionomer interlayer can be applied directly to the anode side of the anion exchange membrane before application of the anode catalyst. Such interlayer provides a hydroxide-conducting network. All experiments used PAP membranes and ionomers. The PAP membranes and ionomers are described in U.S. patent Ser. No. 10/290,890, U.S. application Ser. No. 16/651,622, and PCT Publication No, WO 2019/068051, herein incorporated by reference in their entirety A preferred anode ionomer is PAP-TP-85-MQN.

A current is supplied to the AEMEL by a power source.

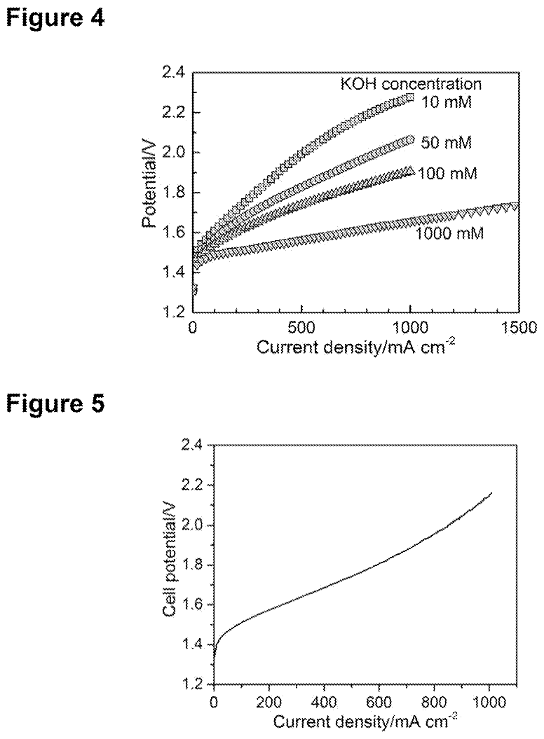

An example of an HEMEL described herein is a single cell assembled by using a PVC catalyst (TKK) as cathode catalyst, FeₓNi_{y}OOH-20F as anode catalyst, as well as alkali-stable and highly OH— conductive PAP-TP-85 HEM and HEIs previously reported with an IEC of 2.4 mmol g⁻¹.^{[32,32]} The Pt/C catalyst and PAP-TP-85 HEIs are sprayed on the HEM to form a porous cathode with a Pt loading of 0.94 mg_{Pt} cm⁻² and HEI loading of 30 wt. % (as shown in FIG. 3), where catalyst particles form an electron-conducting network, and the HEIs adsorbed at the catalyst surface form a OH⁻ conducting network. The anode is a self-supported FeₓNi_{y}OOH-20F electrode with a catalyst loading of 4.8 mg cm⁻² coated with PAP-TP-85-MQN HEI with an IEC of 3.2 mmol g⁻¹ (as described at Example 13 of PCT Publication No. WO 2019/068051). FIG. 4 shows the polarization curves of HEMELs working with KOH aqueous electrolyte at 80° C. Performance was significantly improved by increasing the KOH concentration from 10 to 1000 mM, since externally supplying OH⁻ ions improves the ionic conductivity of the HEM and HEI, decreases the ohmic resistance (from 0.32 ohm cm² for 10 mM KOH to 0.06 ohm cm² for 1000 mM KOH), and increases the reaction rate towards the OER. The performance was as high as 1500 mA cm⁻² at 174 V using a PAP HEM and 1000 mM KOH aqueous electrolyte, which was much higher than that of Zirfon™ membrane-based AELs under similar experimental conditions (FIG. 5), further illustrating the high ionic conductivity of the PAP HEM. Moreover, the HEMEL performance is much better than that of previously reported solid-state alkaline water electrolyzers using a 1.0 M KOH electrolyte (FIG. 5),^{[34-37]} and approaches that of PGM catalyst-based PEMELs as shown in Table 2:

TABLE 2
MEA specifications and performance of HEMELs working with 1.0M KOH
electrolyte compared with that of previously reported PEMELs.

| | Cathode | Anode | | | | |
|---|---|---|---|---|---|---|
| | Loading | Loading | | Temp. | | |
| Type | (mg_{Pt}/cm²) | (mg/cm²) | Electrolyte | (° C.) | Performance | Reference |
| HEMELs | Pt/C | FeₓNi_{y}OOH—20F | KOH | 80 | 1.50 A cm⁻²@1.74 V | Inventive |
| | 0.94 | 4.8 | (1.0M) | | | HEMEL |
| PEMELs | Pt black | Ir black | H₂O | 45 | 1.35 A cm⁻²@1.80 V | ^{[74]} |
| | 1.0 | 1.5 | | | | |
| PEMELs | Pt/C | Y_{1.75}Ca_{0.25}Ru₂O₇ | H₂O | 60 | 1.25 A cm⁻²@1.70 V | ^{[75]} |
| | 1.5 | 4.1 | | | | |
| PEMELs | Pt/C | IrO₂—Ir | H₂O | 80 | 1.4 A cm⁻²@1.70 V | ^{[76]} |
| | 1.0 | 1.0 | | | | |
| PEMELs | Pt/C | Ir_{0.7}Ru_{0.3}Oₓ | H₂O | 80 | 1.7 A cm⁻²@1.80 V | ^{[77]} |
| | 0.5 | 1.8 | | | | |
| PEMELs | Pt/C | Ir-ND/ATO | H₂O | 80 | 1.5 A cm⁻²@1.80 V | ^{[78]} |
| | 0.40 | 1.0 | | | | |
| PEMELs | Pt/C | IrO₂ | H₂O | 80 | 1.4 A cm⁻²@1.80 V | ^{[79]} |
| | 0.25 | 0.71 | | | | |
| PEMELs | Pt/C | IrO₂ | H₂O | 90 | 1.92 A cm⁻²@1.80V | ^{[80]} |
| | 0.40 | 0.10 | | | | |
| PEMELs | Pt/C | Ir_{0.7}Ru_{0.3}Oₓ | H₂O | 90 | 2.6 A cm⁻²@1.80 V | ^{[81]} |
| | 0.50 | 1.5 | | | | |

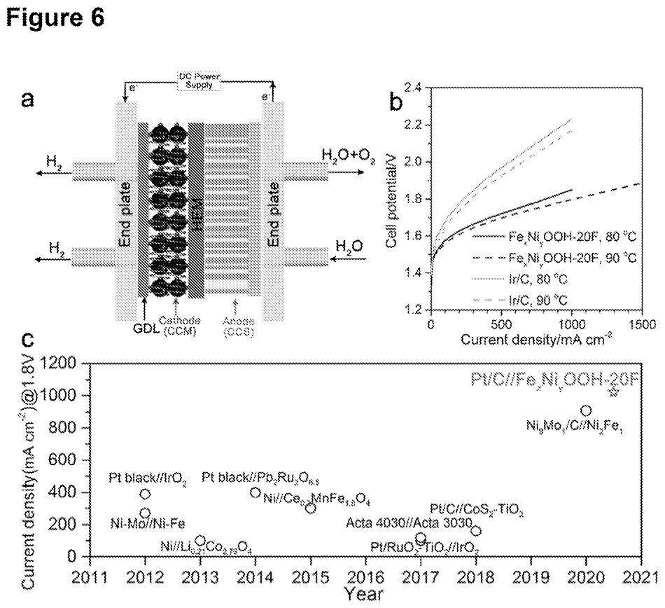

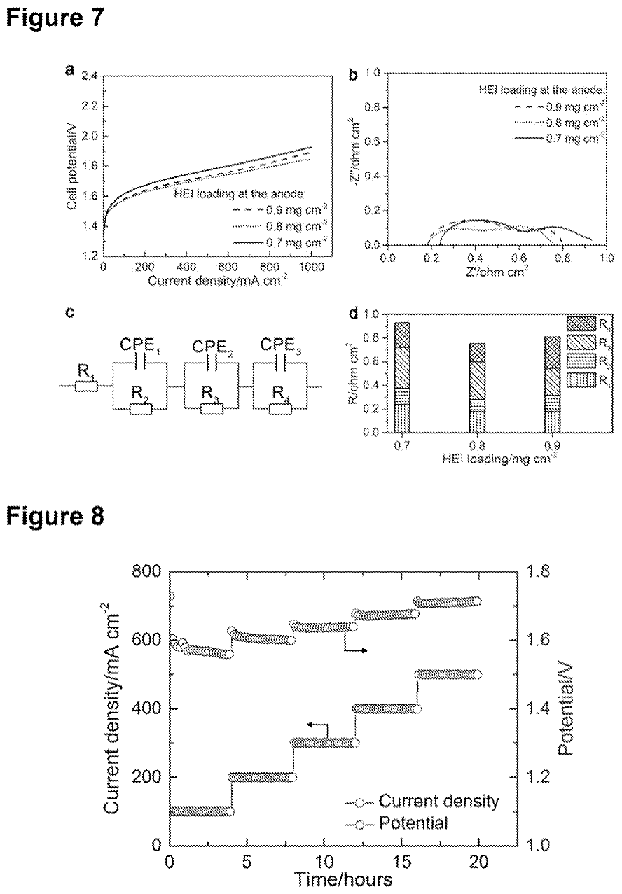

When HEMELs are operated with water instead of alkaline electrolytes, corrosion issues can be avoided. FIG. 6a schematically shows the configuration of a representative water-fed HEMEL, where a PAP-TP-85 HEI and a PVC catalyst are sprayed on to the HEM to form the cathode, and a PAP-TP-85-MQN HEI is loaded at a self-supported FeₓNi_{y}OOH-20F electrode via a dip-coating method to form the anode. FIG. 7a shows the polarization curves of water-fed HEMELs with different HEI loadings at the anode. It is noted that the current density at a cell potential of 1.8 V (j_{1.8}) is greatest at an optimum HEI loading of 0.8 mg cm⁻² because the ion transfer and OER kinetics are improved with increasing HEI loading, shown by the decreased ohmic resistance and OER kinetic resistance in FIGS. 7b and 7d. However, an HEI layer that is too thick at the anode limits the evolution of oxygen gas, as seen from the increase of the mass transfer resistance when the HEI loading is increased to 0.9 mg cm⁻² (FIG. 7d), resulting in a slight deterioration of HEMEL performance.

The performance of the water-fed HEMEL was optimized to a j_{1.8} of 1020 mA cm⁻² at 90° C. (FIG. 6b). By contrast, when FeₓNi_{y}OOH-20F was replaced by a PGM Ir/C catalyst at the anode, the HEMEL performance was significantly decreased, and the j_{1.8} was lowered to 240 mA cm⁻² at 80° C. and 290 mA cm⁻² at 90° C. under the similar experimental conditions. This shows excellent performance of the HEMELs as described herein in comparison to many state-of-art of HEMELs (FIG. 6c)^{(6,7,38-43]} and was even superior to those previously reported to operate with potassium carbonate aqueous electrolytes.^{[44,45]} This outstanding performance can be attributed to several factors as described below.

The low ohmic resistance of the water-fed HEMEL using self-supported FeₓNi_{y}OOH-20F at the anode, which is 0.19 Ωcm², is lower than the 0.23 Ωcm² for previously reported water-fed HEMELs using PGM catalysts,^{[6]} and the 0.30 Ωcm² for Zirfon membrane-based AELs operated with KOH aqueous electrolytes.^{[36]} It is also comparable to that of PEMELs (i.e., 0.10-0.13 Ωcm²).^{[46]}

The self-supported FeₓNi_{y}OOH-nF electrode as an anode catalyst exhibits superior OER activity via F⁻ leaching induced self-reconstruction (Table 1),^{[23,24]} and promotes electron transport from the catalyst layer to the current collector, which results in a lower ohmic resistance (0.19 Ωcm²) and OER kinetic resistance (0.32 Ωcm²), in comparison with 0.33 Ωcm² and 0.58 Ωcm² for an Ir/C catalyst under similar conditions.

The weak metal-fluorine bonds in the electrocatalyst have been shown to gradually evolve into highly active metal-(oxy)hydroxide bonds during CV cycling, as illustrated by the disappearance of (Fe, Ni)—F bonds after numerous continuous cycles. Moreover, the Ni(II)/Ni(III) oxidation peak, which is dependent on the number of exposed NiOOH active sites and is proposed as an index of the OER activity, is apparent in the electrocatalyst, especially after numerous repetitive cycles.

The PAP-TP-85 and PAP-TP-85-MQN HEMS and HEIs show much greater OH⁻ conductivity than previously reported ones, including A201, AS-4, FFA-3, and aQAPS as shown in Table 3:

TABLE 3
The ion exchange capacity (IEC) and OH⁻ conductivity
(σ_{OH}_{^{−}}) of PAP HEM and HEIs compared
with that of previously reported HEMs and HEIs.

| Materials | IEC/mmol g⁻¹ | σ_{OH}_{^{−}}/mS cm⁻² | Ref. |
|---|---|---|---|
| PAP-TP-85 | 2.4 | 78^{a}, 175^{b} | Inventive |
| | | | HEM/HEI |
| PAP-TP-85-MQN | 3.2 | 150^{a}, | Inventive |
| | | | HEM/HEI |
| Tokuyama A201 | 1.8 | 42^{a} | Tokuyama |
| | | | Corporation |
| Tokuyama A901 | 1.8 | 38^{a} | Tokuyama |
| | | | Corporation |
| AS4 | 1.4 | 14^{a} | Tokuyama |
| | | | Corporation |
| FFA-3 | 2.0 | 30^{a} | [59] |
| aQAPS | 1.0 | 100^{b} | [60] |
| LDPE | 2.6 | 145^{c} | [61] |
| QPE-X16Y11 | 1.9 | 144^{b} | [62] |
| PVB-MPY | 1.7 | 159^{c} | [63] |
| NC5Q-PPQ-60 | 2.6 | 96^{b} | [64] |
| S70P30 | 4.0 | 115^{b} | [65] |
| PFB | 3.6 | 124^{b} | [66] |
| 50PPOFC6NC6 | 1.9 | 42^{a}, 140^{b} | [67] |
| BPN1-100 | 2.7 | 122^{b} | [68] |
| QPAEN-0.4 | 1.8 | 116^{b} | [69] |
| FPAE-3B-3.0-PD | 1.2 | 98^{b} | [70] |
| QAPPT | 2.5 | 137^{b} | [71] |
| TPQPOH | 1.1 | 27^{a} | [72] |
| PPO_Pip1.7 | 1.7 | 18^{a}, 101^{b} | [73] |

^{a}Data were taken at room temperature in liquid water.
^{b}Data were taken at T = 80° C. in liquid water.
^{c}Data were taken at T = 80° C. at 95% relative humidity.

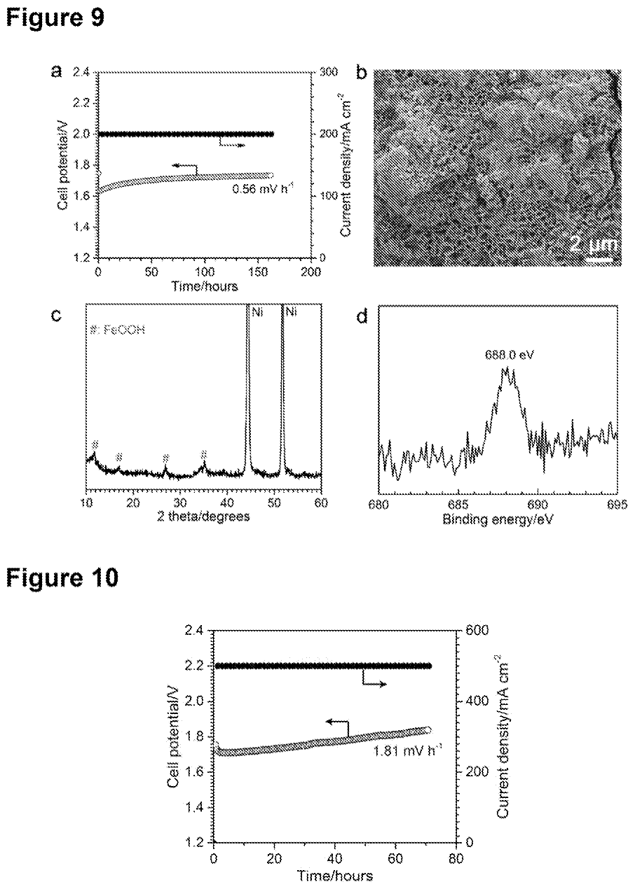

Durability is an important consideration for commercial applications. Most water-fed HEMELs reported previously showed short lifetimes (<100 hours) and the performance rapidly deteriorates during durability tests, which is mainly due to irreversible chemical degradation of the HEI and HEM, especially for an HEI in intimate contact with the catalysts.^{[8,42,47]} The short-term durability of a water-fed HEMEL was first investigated at different current densities. It was observed that the cell potential experienced almost no decay after 4 continuous hours of operation at current densities of 100 to 500 mA cm⁻² at 80° C. (FIG. 8). FIG. 9a shows long-term durability performance measured under a current density of 200 mA cm⁻² at 80° C. The cell potential decreases from 1.71 to 1.63 V in the initial 3 h of operation due to the catalyst activation and full HCO₃⁻/OH⁻ exchange of HEM and HEIS, and slowly increases with the rate of 0.56 my h⁻¹ in the following 160 h of operation. Even at 500 mA cm⁻², the cell potential is still lower than 1.9 V after a continuous 70 h operation at 80° C., and the degradation rate is 1.81 mV h⁻¹ (FIG. 10). Compared with previously reported water-fed HEMELs as shown in Table 4, long-term durability performance is significantly improved:

TABLE 4
The durability performance of water-fed HEMELs compared with that
of previously reported HEMELs working under the similar conditions.

| | | Current density | Time | Decay rate | |
|---|---|---|---|---|---|
| HEM | HEI | (mA cm⁻²) | (hours) | (mV h⁻¹) | Ref. |
| PAP-TP-85 | PAP-TP-85/ | 200 | 160 | 0.56 | Inventive |
| | PAP-TP-85-MQN | 500 | 70 | 1.81 | HEMEL |
| A201 | A-Radel | 200 | 300 | 0.80 | [6] |
| xQAPS | xQAPS | 400 | 8 | 6.3 | [7] |
| PSF-TMA⁺OH⁻ | PSF-TMA⁺OH⁻ | 200 | 6 | 133.3 | [42] |
| qPVB/OH⁻ | QPDTB-OH⁻ | 300 | 10 | 22.3 | [41] |
| A201 | AS4 | 50 | 200 | 0.80 | [82] |
| HTMA-DAPP | TMA-70 | 200 | <8 | 31.2 | [1] |

The improved long-term durability performance is attributed to the following features. The PAP HEM and HEIs demonstrated good alkaline stability, and experienced no obvious degradation in a 1.0 M KOH solution for 2000 h at 100° C.^{[32,33]}. Additionally, the self-supported FeₓNi_{y}OOH-20F electrode showed excellent structural and chemical stability during the catalytic process. It was found that the vertically oriented nanosheet array structure (FIG. 9b), and the crystal phase and chemical configurations of FeₓNi_{y}OOH-20F were well preserved after 160 h of continuous operation at 200 mA cm⁻² and 80° C. (FIGS. 9c and 8). The peak at 688.0 eV corresponding to the C—F bond instead of (Fe, Ni)—F bond appears in high resolution F is XPS spectrum (FIG. 9d), revealing that HEI molecules are still attached at the catalyst surface after the long-term operation to facilitate the OH⁻ transport, and F⁻ anions in the FeₓNi_{y}OOH-20F catalyst are leached during the OER process due to weak metal-fluorine bonds.^{[24]} However, the outermost HEI layer at the anode surface is mostly degraded and/or flushed by water flow and oxygen gas (FIGS. 10 and 9b), which resulted in the cell potential slowly increasing with prolonged measurement time.

With the combination of HEM, HEI, and OER anode catalyst, the single-cell HEMEL as described herein can achieve excellent performance and long-term durability. The HEMELs as described herein are an effective water electrolysis technology for narrowing the gap between lab and commercial-scale production of low-cost hydrogen using intermittent renewable energy sources.

Hydrogen gas has been used in industry for refining petroleum to lower its sulfur content, treating metals, producing fertilizers, purifying glass, protecting electronics, and processing foods, Hydrogen gas can also be used as hydrogen fuel such as in hydrogen fuel cells to produce electricity to power electrical systems.

Hydrogen gas produced via the AEMEL using intermittent renewable energies (wind and solar powers), seawater, and waste water can increase the utilization efficiency of the renewable energies and lower the cost of hydrogen production.

AEMEL is one of the promising distributed electrolysis models for producing hydrogen gas owing to low cost, high voltage efficiency, high hydrogen purity, and high outlet pressure.

The anode is not only used for water electrolysis to produce hydrogen gas, but also can be used in flow cells for facilitating the electrochemical reduction of carbon dioxide and nitrogen gas.

Having described the invention in detail, it will be apparent that modifications and variations are possible without departing from the scope of the invention defined in the appended claims.

### EXAMPLES

The following non-limiting examples are provided to further illustrate the present invention.

### Example 1: Synthesis of Nickel Iron Oxyhydroxide and Fluoride-Incorporated Nickel Iron Oxyhydroxide Nanosheet Arrays Directly Grown on Compressed Nickel Foam

After being compressed at a force of 1000 lbs., Ni foams (2.5 cm×2.5 cm) with a thickness of 280 μm were immersed into a 1.0 M H₂SO₄ aqueous solution for 1 hour to clean residual oxides, and were then washed by deionized water to completely remove the acid. Fluoride-incorporated nickel iron oxyhydroxide catalysts directly grown on compressed Ni foams were prepared via a one-step method. Iron nitrate hexahydrate (Fe(NO₃)₃.6H₂O, 20 mM) and sodium fluoride (NaF, 10-30 mM) were dissolved in 20 mL deionized water. O₂ gas was then bubbled through the solution for 10 min, Subsequently, compressed Ni foams were immersed into the above solution at room temperature for 12 h with a continuous O₂ flow above the liquid surface. After being washed by deionized water, the products were labeled as FeₓNi_{y}OOH-nF, where n symbolizes the NaF concentrations (10, 20, and 30 mM) in the reactants.

For comparison, nickel iron oxyhydroxide (FeₓNi_{y}OOH) catalysts were synthesized according to the same procedures without adding NaF during the preparation process.

The mass loadings of FeₓNiᵥOOH and FeₓNi_{y}OOH-nF were ˜4.8 mg cm⁻².

### Example 21 Electrocatalyst Characterization

Scanning electron microscopy (SEM) and enemy dispersive spectrometer (EDS) mapping analysis were carried out on an Auriga 60 Crossbeam at an accelerating voltage of 3 kV. Transmission electron microscopy (TEM) and scanning transmission electron microscopy (STEM) were measured on a Talos™ F200C at an accelerating voltage of 200 kV. X-ray diffraction (XRD) was performed on a Bruker D8 XRD with Cu kα irradiation (λ=1.5406 Å), with a step size of 0.05° and scan rate of 0.025° s⁻¹. X-ray photoelectron spectroscopy (XPS) was measured using a Thermo Scientific™ K-Alpha™ XPS system with a resolution of 0.3-0.5 eV from a monochromated aluminum anode X-ray source with Kα radiation (1486.6 eV), FeₓNi_{y}OOH and FeₓNi_{y}OHH-nF catalysts were detached from compressed Ni foams via ultra-sonication, and then dissolved in an aqueous HNO₃ solution (2 wt. %) to determine the Fe/Ni molar ratio via microwave plasma-atom emission spectrometer (MP-AES, Agilent 4100).

FIG. 1a schematically shows the formation mechanism of fluoride-incorporated nickel iron oxyhydroxide in-situ grown on compressed Ni foams.

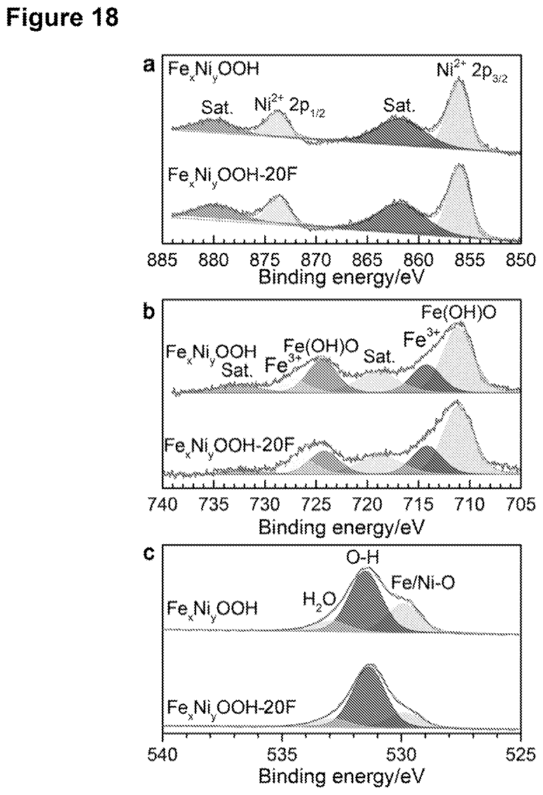

XRD patterns in FIG. 1b show the diffraction peaks (2θ=44.5° and 51.8°) of Ni foams alongside three other diffraction peaks at 2θ=11.9°, 16.9°, and 35.3°. These are the characteristic peaks of FeOOH in the FeₓNi_{y}OOH and FeₓNi_{y}OOH-20F (JCPDS 01-075-1594), and they are in accordance with the appearance of Fe(III)-(OH)O and Ni(II)-OH species in high-resolution Fe 2p and Ni 2p XPS spectra (FIG. 18).

The F 1s peak at the binding energy of 684.0 eV in the high-resolution F 1s XPS spectra reveals the existence of a (Fe, Ni)—F bond in the FeₓNi_{y}OOH-20F (FIG. 1c).

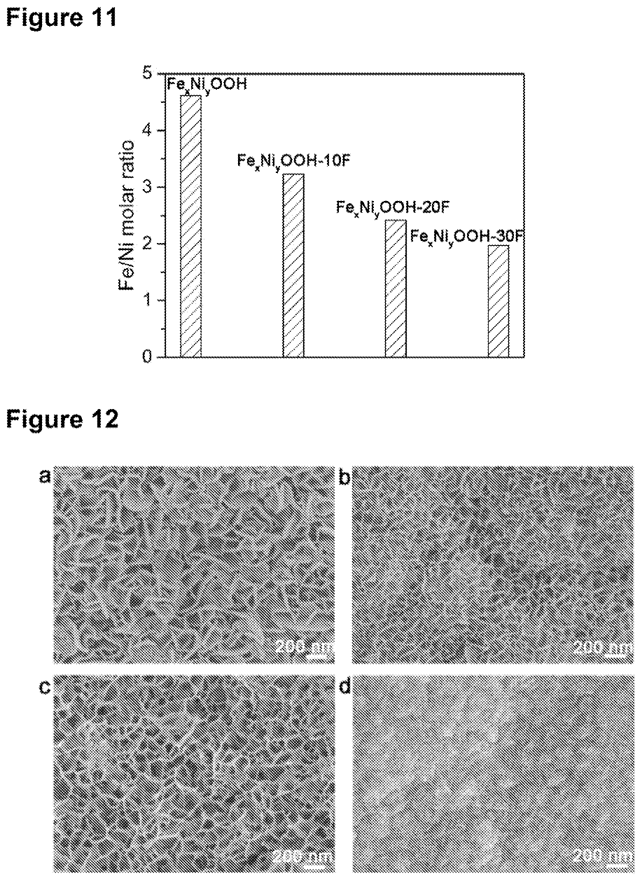

The Fe/Ni molar ratio determined by microwave plasma-atom emission spectrometer (MP-AES) was 4.6 for the FeₓNi_{y}OOH and decreased to 2.0 when the F⁻ concentration was increased to 30 mM in the reactants (FIG. 11). This is because the strong coordination interaction between F⁻ anions and Fe³⁺ cations with a stability constant (Kr) of 5.88×10¹⁵ at 25° C. results in a decreasing free Fe³⁺ concentration in the reactants.

Scanning electron microscopy (SEM) images in FIGS. 1d and 12a show a three-dimensional sponge-like network structure of the FeₓNi_{y}OOH and FeₓNi_{y}OOH-20F, which are composed of vertically oriented and interpenetrating nanosheet arrays. Moreover, the nanosheet thickness and sizes gradually decreased with increasing F concentrations (FIG. 12), which may be due to the lattice strain caused by the F⁻ incorporation. The high-magnification TEM image of FeₓNi_{y}OOH-20F in FIG. 1e confirms the ultrathin nanosheet structure with a thickness of 2˜3 nm, and the lattice fringes with d=0.52 nm are corresponding to the lattice distance of (200) planes of FeOOH (FIG. 1f), in accordance with the XRD results.

### Example 3: Electrochemical Electrocatalyst Characterization

The OER catalytic activities of the electrocatalysts of Example 1 were measured on VMP-300 multichannel electrochemical workstations in an O₂-saturated 1.0 M KOH solution. The overpotential at 100 mA cm⁻² (η₁₀₀) was calculated as follows:

η=E₁₀₀−1.23 (1)

where E₁₀₀ is the OER polarization potential relative to the RHE at 100 mA m⁻² corrected by IR-compensation, and the O₂/H₂O equilibrium potential is 1.23 V.

Ir/vulcan XC-72 catalyst (20 wt. %), Nafion™ solution (40 μL), and isopropanol (960 μL) were sonicated in an ice-water bath for 1 h, and were then sprayed onto two sides of compressed Ni foam with a total mass loading of ˜4.8 mg cm⁻² (the same as with fluoride-incorporated nickel iron oxyhydroxide) as a comparative benchmark PGM OER catalyst (indicated as “Ir/C” in the Figures).

The internal resistance (R) is obtained from electrochemical impedance spectroscopy (EIS) measured at open-circuit voltage in a frequency range from 100 kHz to 0.01 Hz at 10 mV. The electrochemically active surface area (ECSA) is calculated on the basis of the electrochemical double-layer capacitance (C_{dl}) of FeₓNi_{y}OOH and FeₓNi_{y}OOH-nF electrodes in a N₂-saturated 1.0 M KOH solution. The measured current (i_{c}, mA cm⁻²) in the non-Faradaic potential region is supposed to originate from double-layer charging, and thus the C_{dl} is obtained from the double-layer charging current (i_{c}, mA cm⁻²) and scan rate (v, mV s⁻¹) according to the following equation:

C_{dl}=i_{c}iv (2)

The ECSA and roughness factor (RF) are estimated from the C_{dl} according to equations 3 and 4:

ECSA=C_{dl}/Cₓ (3)

RF=ECSA/A (4)

where Cₛ is the specific capacitance of the material with an atomically smooth planar surface, and is supposed to be 0.040 mF cm⁻² in 1.0 M KOH^{[49]}. A is the geometric area of the electrode (2.0 cm²).

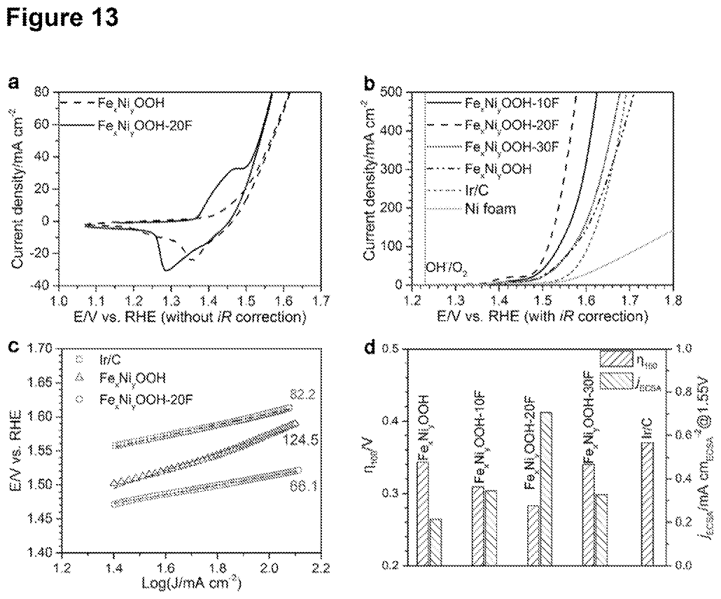

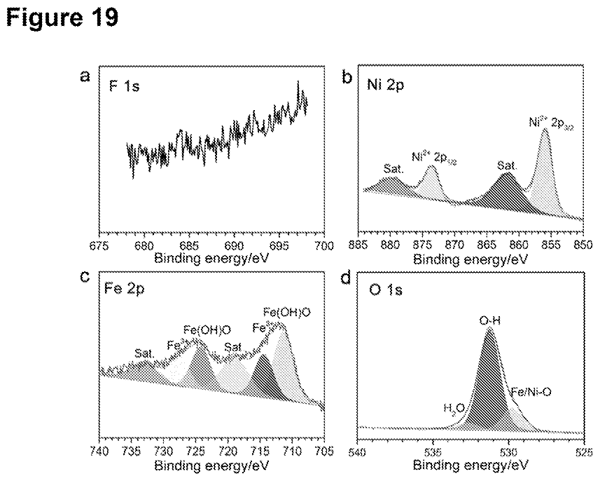

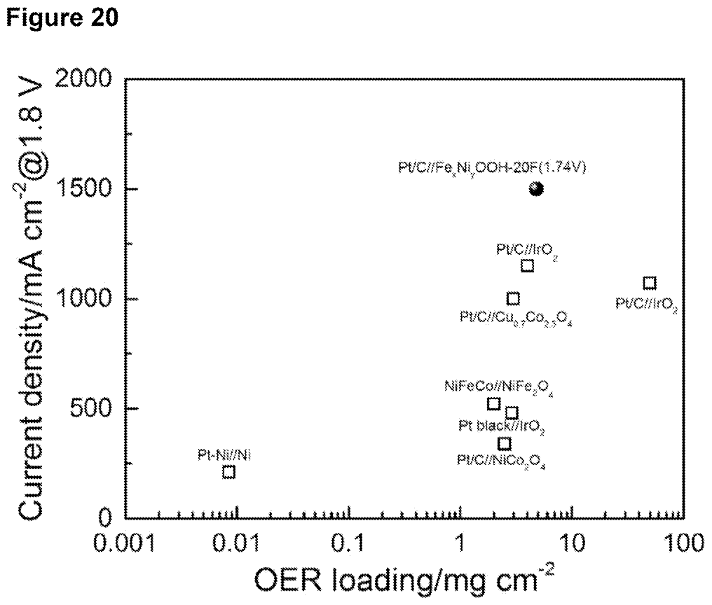

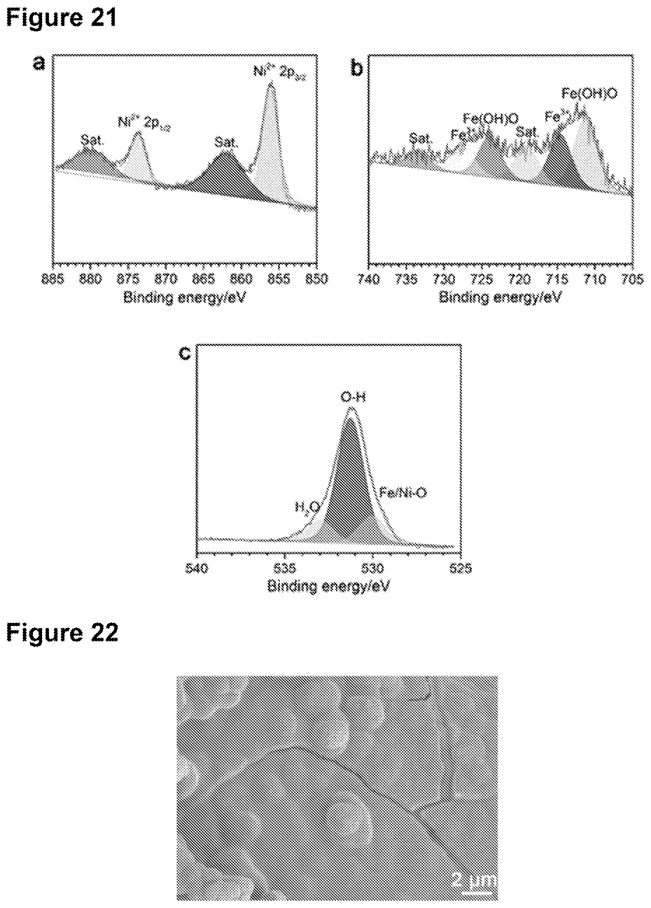

The OER activities of FeₓNi_{y}OOH and FeₓNi_{y}OOH-nF catalysts were measured in O₂-saturated 1.0 M KOH aqueous electrolyte using cyclic voltammetry (CV) and linear sweep voltammetry (LSV) techniques. As seen from CV curves in the first 20 cycles shown in FIG. 17, the OER current is significantly increased for FeₓNi_{y}OOH-20F. This is accompanied by a positive shift of the Ni(II)/Ni(III) oxidation peak potential, while there is no obvious change for FeₓNi_{y}OOH under similar measurements. The weak metal-fluorine bonds in the FeₓNi_{y}OOH-20F are considered to gradually evolve into highly active metal-(oxy)hydroxide bonds during CV cycling,^{[23,24]} as illustrated by the disappearance of (Fe, Ni)—F bonds after 20 continuous cycles (FIG. 19). Moreover, the Ni(II)/Ni(III) oxidation peak, which is dependent on the number of exposed NiOOH active sites and is proposed as an index of the OER activity,^{[25-28]} is, apparent in the FeₓNi_{y}OOH-20F, especially after 20 repetitive cycles. It is almost unnoticeable in the FeₓNi_{y}OOH (FIG. 13a), further illustrating that the F⁻ ion leaching in the FeₓNi_{y}OOH-20F induces surface reconstruction to expose more NiOOH active sites and enhance catalytic activity.

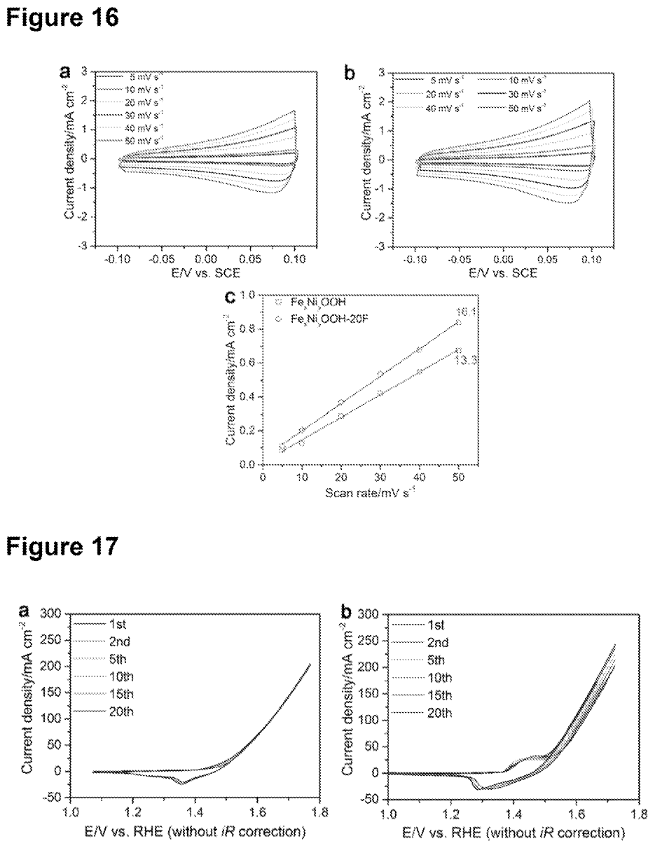

The OER activity is further compared via polarization curves measured at 5 mV s⁻¹ with IR compensation. When FeₓNi_{y}OOH and FeₓNi_{y}OOH-nF species are grown on compressed Ni foams, FeₓNi_{y}OOH-20F shows the highest OER activity among all FeₓNi_{y}OOH and FeₓNi_{y}OOH-nF catalysts and uncoated Ni foam (FIG. 13b). More specifically, the overpotential at 100 mA cm⁻²_{geometric area} (η₁₀₀) of FeₓNi_{y}OOH-20F is 63 mV lower than that of FeₓNi_{y}OOH, and is even 90 mV lower than that of a RGM Ir/C catalyst. The extraordinary OER activity is mainly ascribed to two factors. First, the F⁻ leaching induces the formation of a catalytic active layer at the surface to improve the electronic conductivity, electron transport, and mass transfer^{[23]}. This is also illustrated by the decrease in ohmic resistance, charge transfer resistance, and mass transport resistance from the FeₓNi_{y}OOH to the FeₓNi_{y}OOH-20F catalyst (FIG. 15). Second, the self-reconstruction caused by F⁻ leaching increases the number of exposed active sites and the electrochemically active surface area (ECSA), shown by the increase in electric double layer capacitance (C_{dl}) in the non-faradic region from 13.3 mF cm⁻² for FeₓNi_{y}OOH to 16.1 mF cm⁻² for FeₓNi_{y}OOH-20F (FIG. 16). A smaller Tafel slope (66.1 mV dec⁻¹) for FeₓNi_{y}OOH-20F, in comparison with 124.5 mV dec⁻¹ for FeₓNi_{y}OOH and 82.2 mV dec⁻¹ for an IOC catalyst, shows further evidence of improved OER kinetics with F⁻ incorporation and leaching (FIG. 13c). FIG. 13d summarizes the η₁₀₀ and specific current density at 1.55 V vs. RHE normalized with respect to the ECSA (j_{ECSA}@1.55V), The j_{ECSA}@1.55V values of FeₓNi_{y}OOH-nF are all higher than that of FeₓNi_{y}OOH, especially for FeₓNi_{y}OOH-20F, further confirming that the reconstruction induced by F⁻ leaching remarkably boosts the intrinsic OER activity by exposing efficient active species and improving electron transport. Moreover, the optimized FeₓNi_{y}OOH-20F catalyst shows overpotentials of 280 and 348 mV at geometric surface area current densities of 100 and 500 mA cm⁻², respectively, which meets the requirement of industrial applications (<400 mV at 500 mA cm⁻²), and is comparable to previously reported Ni—Fe based catalysts grown on uncompressed metal foams by more complex methods (Table 1).^{[14, 15, 23, 29-31]}

### Example 4: Synthesis of Nickel Iron Cobalt Oxyhydroxide and Fluoride-Incorporated Nickel Iron Oxyhydroxide Nanosheet Arrays Directly Grown on Compressed Nickel Foam

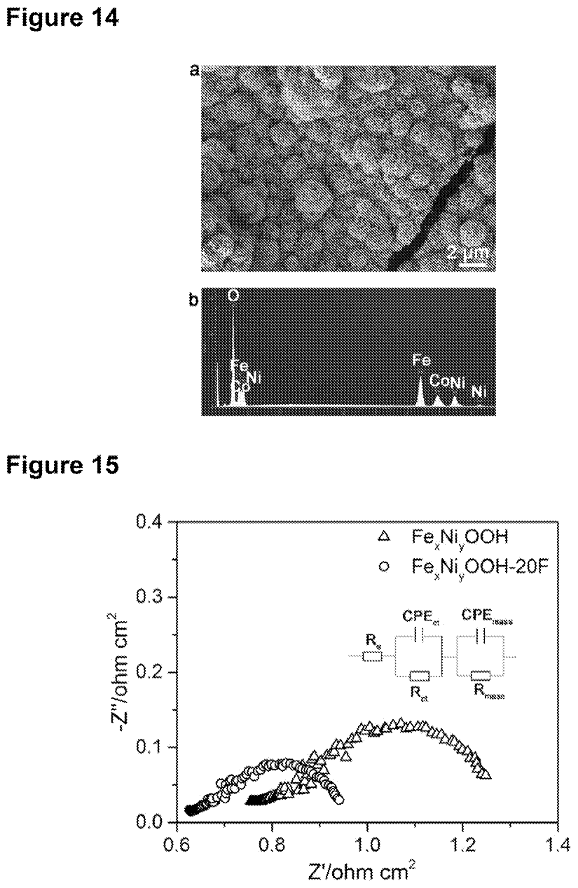

The facile electrocatalyst synthesis method of Example 1 has been used for preparing another multi-metallic oxyhydroxide nanosheet array (Fe, Ni, Co)OOH (FIG. 14), After being compressed at a force of 1000 lbs., Ni foams (2.5 cm×2.5 cm) with a thickness of 280 μm were immersed into a 1.0 M H₂SO₄ aqueous solution for 1 hour to clean residual oxides, and were then washed by deionized water to completely remove the acid. Nickel iron cobalt oxyhydroxide catalysts directly grown on compressed Ni foams were prepared via a one-step method. Iron nitrate hexahydrate (Fe(NO₃)₃.6H₂O, 20 mM) and cobalt nitrate hexahydrate (Co(NO₃)₃.6H₂O, 20 mM) were dissolved in 20 mL deionized water. O₂ gas was then bubbled through the solution for 10 min. Subsequently, compressed Ni foams were immersed into the above solution at room temperature for 12 h with a continuous O₂ flow above the liquid surface. After being washed by deionized water, the product (Fe, Co, Ni)OOH on Ni foam was obtained.

A (Fe, Co, Ni)OOH-nF electrocatalyst could be formed by this method by including sodium fluoride (NaF, 10-30 mM) in the solution with the iron and cobalt nitrate hexahydrates.

### Example 5: Fabrication of HEMELs

The HEMELs include flow channel plates, a cathode gas diffusion layer (GDL), cathode, HEM, and anode as depicted in FIG. 6a. TOP-H-60 Toray carbon paper (5% wet proof) was used as the GDL for the cathode.

A poly(aryl piperidinium) hydroxide exchange membrane (PAP HEM) in carbonate form with a thickness of 20 μm was prepared from N-methyl-4-piperidone, 2,2,2-trifluoroacetophenone and p-terphenyl according to our previous methods,^{[32]} where the molar ratio between N-methyl-4-piperidine and aryl monomers is 85%. Poly(aryl piperidinium) hydroxide exchange ionomers (PAP HEIs) were synthesized via the methods of the PAP HEM,^{[32]} and in carbonate form were dissolved in anhydrous ethanol with a concentration of 5 wt. %, PAP HEIs were PAP-TP-85 in the cathode with an ion exchange capacity (IEC) of 2.4 mmol g⁻¹ and OH⁻ conductivity of 78 mS cm⁻¹ and PAP-TP-85-MQN in the cathode with an IEC of 3.2 mmol g⁻³ and OH⁻ conductivity of 150 mS cm⁻¹ at room temperature.

For the preparation of the cathode, PVC catalysts (47 wt. %, TKK), deionized water, isopropanol, and PAP-TP-85 HEI solution were initially sonicated in an ice-water bath for 1 h to obtain a well-dispersed catalyst ink. The catalyst ink was then sprayed on the PAP HEM using a hand-spray method with the aid of a spray gun (Iwata, Japan) to create a cathode (hydrogen evolution electrode) with a Pt loading of 0.94 mg_{Pt} cm⁻² and HEI loading of 30 wt. %. The electrode area was 5 cm².

For the preparation of the platinum-group-meta. (PGM) free anode, PAP-TP-85-MON HEIs were loaded at the FeₓNi_{y}OOH-20F electrode to form the anode (oxygen evolution electrode) by using the dip-coating method. The HEI loading in the anode was calculated from the weight change for ten samples before and after the dip-coating process.

For comparison, a POM anode was prepared via spraying the catalyst ink composed of Ir/C catalyst (20 wt. %), deionized water, isopropanol, and PAP-TP-85 HEI solution on two sides of compressed Ni foam. The total mass loading of Ir/C catalyst was 4.8 mg cm⁻² and PAP-TP-85 HEI loading was 30 wt. %.

### Example 6: HEMEL Cell Performance Evaluation

The cell performance and durability of HEMELs comprised of a membrane-electrode assembly (MEA), a graphite end plate with triple serpentine channels on the cathode side, and a titanium end plate with triple serpentine channels on the anode side were characterized using the following water electrolysis setup. Aqueous KOH solutions of varying concentrations or pure water were fed into the anode at a flow rate of 3 min⁻¹. Arbin battery testing equipment was used to provide the voltage and current necessary for the water splitting reaction. The polarization curves (current density vs. cell voltage) of HEMELs were recorded at 80° C. and 90° C. by stepping the current density from 10 to 1000 mA cm⁻² with an increment of 10 mA cm⁻², and each current density was held for one minute. The durability was tested at current densities of 200 and 500 mA cm⁻², and the cell potential was recorded every 10 seconds. Electrochemical impedance spectroscopy (EIS) measurements were taken using a Solartron SI 1287 electrochemical interface and a SI 1260 impedance/Gain-phase analyzer at the open circuit voltage (OCV) and a constant current density with an AC oscillation of 10 mV amplitude over frequencies from 100 kHz to 100 mHz. In FIG. 15, electrochemical impedance spectroscopy (EIS) of FeₓNi_{y}OOH and FeₓNi_{y}OOH-20F electrodes is plotted as measured at 1.60 V vs. RHE with an AC oscillation of 10 mV amplitude over frequencies from 100 kHz to 100 mHz. EIS spectra are fitted using an equivalent circuit composed of the ohmic resistance (Rₛ) in series with two parallel units of the charge transfer resistance at the interfaces of the catalysts and the electrolyte (R_{ct}), mass transport resistance (Rₘₐₛₛ), and constant phase elements (CPE_{ct} and CPEₘₐₛₛ)(InSet).^{[10,11]}

### REFERENCES

[1] S. Pivovar, N. Rustagi, S. Satyapal, Electrochem. Soc. Interface 2018, 27, 47-52,
[2] R. L. LeRoy, Int. J. Hydrogen Energy 1983, 8, 401-417,
[3] G. Schiller, R. Henne, P. Mohr, V. Peinecke, Int. J. Hydrogen Energy 1998, 23, 761-765.
[4] M. Schalenbach, G. Tjarks, M. Carmo, W. Lueke, M. Mueller, D. Stolten, J. Electrochem. Soc. 2016, 163, F3197-F3208.
[5] Y. Zhang, C. Wang, N. Wan, Z. Liu, Z. Mao, Electrochem. commun. 2007, 9, 667-670.
[6] Y. Lang, a Chen, A. J. Mendoza, T. B. Tighe, M. A. Hickner. C. Y. Wang, J. Am. Chem. Sac, 2012, 134, 9054-9057.
[7] L. Xiao, S. Zhang, J. Pan, C. Yang, M. He, L. Zhuang, J. Lu, Energy Environ. Sci. 2012, 5, 7869-7871.
[8] a Li, E. J. Park, W. Zhu, Q. Shi, Y. Zhou, H. Tian, V. Lin, A. Serov, B. Zulevi, E. D. Baca, et al., Nat. Energy 2020, DOI 10.1038/s41560-020-0577-x.
[9] S. Noh, J. Y. Jean, S. Adhikari, Y. S. Kim, C. Bae, Acc. Chem. Res. 2019, 52, 2745-2755.
[10] H. A. Kostalik, T. J. Clark, N. J. Robertson, P. F. Mutolo, J. M. Longo, H. D. Abruña, C. W. Coates, Macromolecules 2010, 43, 7147-7150,
[11] O. D. Thomas, K. J. W. V. Soo, T. J. Peckham, M. P. Kulkarni, S. Holdcroft, J. Am. Chem. Sac, 2012, 134, 10-13.
[12] K. Zeng, D. Zhang, Prog. Energy Combust. Sci. 2010, 36, 307-326.
[13] L. Han, S. Dong, E. Wang, Adv. Mater. 2016, 28, 9266-9291.
[14] X. Lu, C, Zhao, Nat. Commun. 2016, 6, DOI 10.1038/ncomms7616.
[15] Y. Liu, X Liang, L. Cu, Y. Zhang, G. D. Li, X. Zou, J. S. Chen, Nat. Commun. 2018, 9, DOI 10.1038/s41467-018-05019-5.
[16] P. He, X.-Y. Yu, X. W. D. Lou, Angew. Chemie 2017, 129, 3955-3958.
[17] C. Hu, J. Liu, J. Wang, W. She, J. Xiao, J, Xi, Z. Bai, S. Wang, ACS Appl. Mater. Interfaces 2018, 10, 33124-33134.
[18] Y. Tong, P. Chen, T. Zhou, K. Xu, W. Chu, C. Wu, Y. Xie, Angew. Chemie 2017, 129, 7227-7231.
[19] L. L. Fang, a Yu, Y. Wu, G. D. Li, H. Li, Y. Sun, T. Asefa, W. Chen, X. Zou, J. Am. Chem. Soc. 2015, 137, 14023-14026.
[20] W. Chen, Y. Liu, Y. Li, J. Sun, Y. Qiu, C. Liu, G. Zhou, Y. Cui, Nano Lett. 2016, 16, 7588-7596.
[21] J. Yin, V. Li, F. Lv, M. Lu, K. Sun, W. Wang, L. Wang, F. Cheng, Y. Li, P. Xi, et al., Adv. Mater. 2017, 29, 1704681.
[22] P. Chen, K. Xu, Z. Fang, Y. Tong, J. Wu, X. Lu, X. Peng, H. Ding, C. Wu, Y. Xie, Angew. Chemie—Int. Ed, 2015,54, 14710-14714.
[23] B. Zhang, K. Jiang, H. Wang, S. Hu, Nano Lett. 2019, 19, 539-537.
[24] P. Chen, T. Zhou, S. Wang, N. Zhang, Y. Tong, H. Ju, W. Chu, C. Wu Y. Xie, Angew. Chemie 2018,130, 15697-15701.
[25] D. Friebel, M. W. Louie, M. Bajdich, K. E. Sanwaid, Y. Cai, A. M. Wise, M. J. Cheng, D. Sokaras, T. C. Wang. R. Aloriso-Mori, et al., J. Am. Chem. Soc. 2015, 137, 1305-1313.
[26] M. Görlin, P. Chernev, J. F. De Ara\dot{u}jo, T. Refer, S. Dresp, B. Paul, R. Krähnert, H. Dau, P. Strasser, J. Am. Chem. Soc. 2016,138,5603-5614,
[27] M. W. Louie, A. T. Bell, J. Am. Chem. Soc. 2013, 135, 12329-12337.
[28] Z. Cai, D. Zhou, M. Wang, S.-M. Bak, Y. Wu, Z. Wu, Y. Tian, X. Xiang, Y. Li, W. Liu, et al., Angew. Chemie 2018,130, 9536-9540.
[29] L. Yu, H. Zhou, J. Sun, F. Qin, F. Yu, J. Bao, Y. Yu, S, Chen, Z. Ran, Energy Environ. Sci. 2017, 10, 1820-1827.
[30] Z. Lu, W, Xu, W. Zhu, Q. Yang, X. Lei, J. Liu, Y. Li, X. Sun, X. Duan. Chem, Commun. 2014, 50, 6479-6482,
[31] E. Detsi, J B Cook, B. K. Lead, C. L, Turner Y L. Liang, S. Robbennolt, S. H. Tolbert, Energy Environ. Sci. 2016, 9, 540-549.
[32] J. Wang, Y. Zhao, B. P. Setzler, S. Rojas-Carbonell, C. Ben Yehuda, A. Amel, M. Page, L. Wang, K. Hu, L. Shi, et al., Nat. Energy 2019, 4, 392-398,
[33] Y. Zhao, B. P. Setzler, J. Wang, J. Nash, T. Wang, B. Xu, Y. Van, Joule 2019, 3, 2472-2484.
[34] J. E. Park, S. Y. Kang. S. H. Oh, J. K. Kim, M. S. Lim, C. Y. Ahn, Y. H. Cho, Y. E. Sung, Electrochim. Acta 2019,295, 99-106.
[35] S. H. Ahn, S. J. Yeo, H. J, Kim, D. Henkensmeier, S. W. Nam, S. K. Kim, J. H. Jang, Appl. Catal. B Environ, 2016, 180, 674-679.
[36] M. R. Kraglund, M. Carmo, G. Schiller, S. A. Ansar, D. Aili, E. Christensen, J. O. Jensen, Energy Environ. Sci. 2019, 12, 3313-3318,
[37] M. K. Cho, H. Y. Park, H. J. Lee, H. J. Kim, A. Lim, D. Henkensmeier, S. J. Yoo, J. Y. Kim, S. Y, Lee, H. S. Park, et al., J. Power Sources 2018, 382, 22-29,
[38] J. Parrondo M. George, C. Capuano, K. E. Ayers, V. Ramani, J. Mater. Chem. A 2015, 3, 10819-10828.
[39] X. Wu, K. Scott, J. Mater. Chem. 2011, 21, 12344-12351.
[40] X. Wu, K. Scott, J. Power Sources 2012, 206, 14-19.
[41] X. Wu, K. Scott, Int. J. Hydrogen Energy 2013, 38, 3123-3129.
[42] J. Parrondo, C. G. Arges, M. Niedzwiecki, E. B. Anderson, K. E. Ayers, V. Ramani, RSC Adv. 2014, 4, 9875-9879.
[43] I. Vincent, A. Kruger, D. Bessarabov. Int. J. Hydrogen Energy 2017, 42, 10752-10761.
[44] C. C. Pavel, F. Cecconi, C. Emiliani, S. Santiccioli, A. Scaffidi, S. Catanorchi, M. Comotti, Angew. Chemie—Int. Ed. 2014, 53, 1378-1381.
[45] H. Ito, N. Kawaguchi, S. Someya, T. Munakata, Electrochim. Acta 2019, 297, 188-196.
[46] H. Ito, T. Maeda, A. Nakano, A. Kato, T. Yoshida, Electrochim. Acta 2013, 100, 242-248.
[47] C. G. Arges, V. K. Raman, P. N. Pintauro, Electrochim. Soc. Interface 2010, 19, 31-35.
[48] H. G. Yang, G. Liu, S. Z. Qiao, C. H. Sun, Y. G. Jin, S. C. Smith, J. Zou, H. M. Cheng, G. Q. Lu, J. Am. Chem. Soc. 2009, 131, 4078-4083.
[49] C. C. L. McCrory, S. Jung, J. C. Peters, T. F. Jaramillo, J. Am. Chem. Soc. 2013, 135, 16977-16987.
[50] M. A. Peck, M. A. Langell, Chem. Mater. 2012, 24, 4483-4490.
[51] A. P. Grosvenor, B. A. Kobe, M. C. Biesinger, N. S. McIntyre, Surf, Interface Anal. 2004, 36, 1564-1574.
[52] A. Oszkó, J. Kiss, I. Kiricsi, Phys. Chem. Chem. Phys. 1999, 1, 2565-2568.
[53] T. Yamashita, P. Hayes, Appl. Surf. Sci. 2008, 254, 2441-2449.
[54] S. Lee, J. Y. Cheon, W. J. Lee S. O. Kim, S. H. Joo, S. Park, Carbon N. Y. 2014, 80, 127-134.
[55] J. H. Linn, W. E. Swartz, Appl. Surf. Sci. 1984, 20, 154-166.
[56] X. Wang, Y. V. Kolen'Ko, X. Q. Bao, K. Kovnir, L. Liu, Angew. Chemie—Int, Ed. 2015, 54, 8188-8192.
[57] C. Dong, Kou, H. Gao, Z. Peng, Z. Zhang, Adv. Energy Maters 2018, 8, DOI 10.1002/aenm.201701347.
[58] P. Lettenmeier, S. Kolb, F. Burggraf, A. S. Gaga, K. A. Friedrich, J. Power Sources 2016, 311, 153-158.
[59] M. Carmo, G. Doubek, R. C. Sekoi, M. Linardi, A. D. Taylor, J. Power Sources 2013, 230, 169-175.
[60] J. Pan, C. Chen, Li, L. Wang, L. Tan, G. Li, X. Tang, L. Xiao, J. Lu, L. Zhuang, Energy Environ Sci. 2014, 7, 354-360.
[61] L. Wang, J. J. Brink, Y. Liu, A. M. Herring, J. Ponce-Gonzalez, D. K. Whelligan, J. R. Varcoe, Energy Environ. Sci. 2017, 10, 2154-2167.
[62] M. Tanaka, K. Fukasawa, E. Nishino, S. Yamaguchi, K. Yamada, H. Tanaka, B. Bae, K. Miyatake, M. Watanabe, J. Am. Chem. Soc. 2011, 133, 10646-10654.
[63] J. Ponce-González, D. K. Whelligan, L. Wang, R. Bance-Soualhi, Y. Wang, Y. Peng, H. Peng, D. C. Apperley, H. N. Sarode, T. P. Pandey, et al, Energy Environ. Sci. 2016, 9,3724-3735,
[64] J. Pan, J. Han, L. Zhu, M. A. Hickner, Chem. Mater. 2017, 29, 5321-5330.
[65] T. H. Pham, J. S. Olsson, P. Jannasch, J. Am. Chem. Soc. 2017, 139, 2888-2891.
[66] W. H. Lee, A. D. Mohanty, C. Bae, ACS Macro Lett. 2015, 4, 453-457.
[67] L. Zhu, J. Pan, C. M. Christensen, B. Lin, M. A. Hickner, Macromolecules 2016, 49, 3300-3309.
[68] E. J. Park, C. B. Ca nano, K. E. Ayers, C. Bae, J. Power Sources 2018, 375, 367-372.
[69] E. N. Hu, C. X. Lin, F. H. Liu, X. Q. Wang, Q. G. Zhang, A. M. Zhu, Q. L. Liu, J. Memb. Sci. 2018, 550, 254-265.
[70] X. Q. Wang, C. X. Lin, F. H. Liu, L. Li, Q. Yang, Q. G. Zhang, A. M. Zhu, Q. L. Liu, J. Mater. Chem. A 2018, 6, 12455-12465.
[71] H. Peng, Q. Li, M. Hu, L. Xiao, J. Lu, L. Zhuang, J. Power Sources 2018, 390, 165-167.
[72] S. Gu, R. Cai, T. Luo, Z. Chen, M. Sun, Y. Liu, G. He, Y. Yan, Angew. Chemie—Int. Ed. 2009, 48, 6499-6502,
[73] J. S. Olsson, T. H. Pham, P. Jannasch, Macromolecules 2017, 50, 2784-2793.
[74] L. Ma, S. Sui, Zhai, Int. J. Hydrogen Energy 2009, 34, 678-684.
[75] Q. Feng, Z. Zhao, X. Z. Yuan, H Li, H. Wang, Appl. Catal. B Environ. 2020, 260, DOI 10.1016/j.apcatb.2019.118176.
[76] P. Lettenmeier, L. Wang, U. Golla-Schindler, P. Gazdzicki, N. A. Cañes, M. Handl, R. Hiesgen, S. S. Hosseiny, A. S. Gaga, K. A. Friedrich, Angew. Chemie 2016, 128, 752-756.
[77] M. Faustini, M. Giraud, D. Jones, J. Rozière, M. Dupont, T. R. Porter, S. Nowak, M. Bahri, O. Ersen, C. Sanchez, et al., Adv. Energy Mater. 2019, 9, DOI 10.1002/aenm.201802136.
[78] H. S. Oh, H. N. Nong, T. Reier, M. Gliech, P. Strasser, Chem. Sci. 2015, 6, 3321-3328.
[79] C. Rozain, E. Mayousse, N. Guillet, P. Millet, Appl. Catel. B Environ. 2016, 182, 153-160.
[80] B. S. Lee, S. H. Ahn, H. Y. Park, I. Choi, S. J. Yoo, H. J. Kim, D. Henkensmeier, J. Y. Kim, S. Park, S. W. Nam, et al., Appl. Catal. B Environ. 2015, 179, 285-291.
[81] S. Siracusano, N. Van Dijk, E. Payne-Johnson, V. Baglio, A. S. Aricò, Appl. Catal. B Environ. 2015, 164, 488-495,
[82] P. Ganesan, A. Sivanantham, S. Shanmugam, J. Mater. Chem. A 2018, 6, 1075-1085.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above devices and methods without departing from the scope of the invention, it is intended that all matter contained in the above description and shown in the accompanying drawings shall be interpreted as illustrative and not in a limiting sense.

1. A fluoride-containing nickel iron oxyhydroxide electrocatalyst.

2. The electrocatalyst of claim 1, having a single F 1s peak as exhibited by high-resolution fluoride (F) 1s X-ray photoelectron spectroscopy spectra.

3. The electrocatalyst of claim 2, wherein the single F 1s peak is at a binding energy of 684.0 eV.

4. The electrocatalyst of claim 1, comprising a three-dimensional sponge-like network structure as determined by scanning electron microscopy (SEM) imaging.

5. The electrocatalyst of claim 1, comprising vertically oriented and interpenetrating nanosheet arrays as determined by high-angle annular dark-field scanning transmission electron microscopy (HAADF-STEM).

6. The electrocatalyst of claim 5, wherein each nanosheet has a thickness of about 2 to 3 nm as determined by high magnification transmission electron microscopy (TEM) imaging.

7. The electrocatalyst of claim 1, wherein a Fe/Ni molar ratio of the electrocatalyst as determined by microwave plasma-atom emission spectrometry (MP-AES) is less than 4.0.

8. The electrocatalyst of claim 7, wherein the Fe/Ni molar ratio of the electrocatalyst as determined by MP-AES is from about 2.0 to about 3.2.

9. The electrocatalyst of claim 1, wherein the electrocatalyst has the formula FeₓNi_{y}OOH wherein x ranges from about 0.75 to about 0.83, and y ranges from about 0.26 to about 0.38.

10. The electrocatalyst of claim 1 further comprising at least one metal in addition to Fe and Ni, the at least one metal comprising Ce, Cr, Cu, Co, Mo, Ru, Pd, Pt, Ir, Rh, Os, Ag, Au, Re, Ta, Ti, V, W, Mn, Zn, Sn, Sb, In, Ga, Bi, Pb, or Zr.

11. A method of preparing a fluoride-containing nickel iron oxyhydroxide electrocatalyst, the method comprising:
immersing a compressed nickel foam in an O₂-rich aqueous solution comprising iron nitrate hexahydrate and sodium fluoride for at least 8 hours under flow of oxygen above the surface of the solution to form the fluoride-containing nickel iron oxyhydroxide electrocatalyst; and
washing the fluoride-containing nickel iron oxyhydroxide electrocatalyst with water.

12. The method of claim 11, further comprising compressing the nickel foam at a force of at least 4448 N to form the compressed nickel foam.

13. The method of claim 11, further comprising immersing the compressed nickel foam in an aqueous acidic solution to remove residual oxides from the compressed nickel foam and then washing the compressed nickel foam with water to remove the acidic solution.

14. The method of claim 11, wherein the iron nitrate hexahydrate and the sodium fluoride are present in the O₂-rich aqueous solution in a molar ratio ranging from about 2:1 to about 1:1.5.

15. The method of claim 11, wherein the O₂-rich aqueous solution is formed by bubbling oxygen gas through an aqueous solution comprised of iron nitrate hexahydrate and sodium fluoride.

16. The method of claim 11, further comprising removing the fluoride-containing nickel iron oxyhydroxide electrocatalyst from the compressed nickel foam.

17. The method of claim 16 wherein the fluoride-containing nickel iron oxyhydroxide electrocatalyst is removed via ultra-sonication.

18. (canceled)

19. A platinum-group-metal (PGM)-free self-supported oxygen evolution electrode comprising the electrocatalyst of claim 1 within pores of a gas diffusion layer comprising a nickel foam.

20. An anion exchange membrane electrolyzer (AEMEL) for generating hydrogen from water, the AEMEL comprising:
an anode comprising an anode electrocatalyst comprised of the fluoride-containing nickel iron oxyhydroxide electrocatalyst of claim 1 for forming oxygen gas and water from hydroxide ions;
a cathode comprising a cathode electrocatalyst for forming hydrogen gas and hydroxide ions from water; and
an anion exchange membrane being adjacent to and separating the anode and the cathode, and for transporting hydroxide ions from the cathode to the anode.

21. The AEMEL of claim 20, wherein the water feed to the cathode or anode contains an hydroxide-conducting electrolyte for forming oxygen gas and water from hydroxide ions.

22. The AEMEL of claim 21, wherein the hydroxide-conducting electrolyte comprises potassium hydroxide.

23. The AEMEL of claim 20, wherein the water feed to the cathode or anode does not contain an alkaline electrolyte.

24. The AEMEL of claim 20, wherein the fluoride-containing nickel iron oxyhydroxide electrocatalyst is within pores of a gas diffusion layer comprising a nickel foam.

25. The AEMEL of claim 20, wherein the membrane comprises an anion exchange polymer.

26. The AEMEL of claim 25, wherein the anion exchange polymer comprises:
quaternary ammonium or imidazolium groups and a polymer backbone not having ether groups; or
poly(aryl piperidinium), alkylammonium-functionalized poly(aryl alkylene), substituted-imidazolium-functionalized poly(aryl alkylene), alkylammonium-functionalized poly(styrene), substituted-imidazolium-functionalized poly(styrene), alkylammonium-functionalized poly(styrene-co-divinylbenzene), substituted-imidazolium-functionalized poly(styrene-co-divinylbenzene), alkylammonium-functionalized poly(styrene-block-ethylene-co-butadiene-block-styrene), substituted-imidazolium-functionalized, poly(styrene-block-ethylene-co-butadiene-block-styrene), alkylammonium-functionalized poly(ethylene), substituted-imidazolium-functionalized poly(ethylene), alkylammonium-functionalized poly(tetrafluoroethylene), substituted-imidazolium-functionalized poly(tetrafluoroethylene), alkylammonium-functionalized poly(ethylene-co-tetrafluoroethylene), substituted-imidazolium-functionalized poly(ethylene-co-tetrafluoroethylene), polyethyleneimine, poly(diallyl ammonium), or a combination thereof.

27.-28. (canceled)

29. The AEMEL of claim 25, wherein the cathode electrocatalyst comprises silver, a silver alloy, carbon-supported silver, a carbon-supported silver alloy, platinum, a platinum alloy, carbon-supported platinum, a carbon-supported platinum alloy, palladium, a palladium alloy, carbon-supported palladium, a carbon-supported palladium alloy, manganese oxide, a carbon-supported manganese oxide, cobalt oxide, a carbon-supported cobalt oxide, heteroatom-doped carbon (X—C, where X comprises one or more of N, C, B, P, S, Se, or O), metal-heteroatom-carbon (M—X—C, where X comprises one or more of N, C, B, P, S, Se, or O, and M comprises one or more of Fe, Ce, Cr, Cu, Co, Mo, Ni, Ru, Pd, Pt, Ir, Rh, Os, Ag, Au, Re, Ta, Ti, V, W, Mn, Zn, Sn, Sb, In, Ga, Bi, Pb, or Zr), a perovskite (ABX₃ where A comprises one or more of Ca, Sr, Ba, Sc, Y, La, Ce, Zr, Cu, Zn, Sb, Bi, B comprises one or more of Al, Ti, Mn, Fe, Co Ni, W, Pd, and X comprises one or more of O, Se, S), a carbon-supported perovskite (ABX₃ where A comprises one or more of Ca, Sr, Ba, Sc, Y, La, Ce, Zr, Cu, Zn, Sb, Bi, B comprises one or more of Al, Ti, Mn, Fe, Co Ni, W, Pd, and X comprises one or more of O, Se, S), or a combination thereof.

30. The AEMEL of claim 29, wherein the anion exchange polymer comprises poly(arylpiperidinium); or the cathode electrocatalyst comprises carbon-supported platinum.

31. The AEMEL of claim 20 further comprising a gas diffusion layer adjacent the cathode.

32. The AEMEL of claim 20, further comprising an ionomer layer on the cathode and/or an ionomer layer on the anode.
